(19) United States
(12) Patent Application Publication
(10) Pub. No.: US 2026/0281429 A1
(43) Pub. Date: Sep. 17, 2026

(54) INTRA-PREDICTION-BASED IMAGE ENCODING/DECODING METHOD, DEVICE, AND RECORDING MEDIUM STORING BITSTREAMS

(71) Applicant: LG Electronics Inc., Seoul (KR)

(72) Inventors: Hyeong Moon JANG, Seoul (KR); Jung Hak NAM, Seoul (KR); Myungoh HONG, Seoul (KR)

(21) Appl. No.: 19/473,655

(22) PCT Filed: Apr. 19, 2024
(86) PCT No.: PCT/KR2024/005298

§ 371 Date: Oct. 8, 2025

(30) Foreign Application Priority Data
Apr. 19, 2023 (KR) 10-2023-0051621

(51) Int. Cl. H04N 19/593; H04N 19/176

(52) U.S. Cl. CPC H04N 19/593; H04N 19/176

(57) ABSTRACT

Provided are an image encoding/decoding method and device. The image decoding method according to the present disclosure may comprise the steps of: acquiring conversion implementation information indicating whether to implement a conversion; implementing the conversion on a first prescribed adjacent area adjacent to a reference block of the current block on the basis of the conversion implementation information; generating a first prediction block of the current block on the basis of the first adjacent area on which the conversion has been implemented and a second prescribed adjacent area adjacent to the current block; and generating a final prediction block of the current block by implementing the conversion on the first prediction block, wherein the first adjacent area is at a position corresponding to the second adjacent area, and the conversion includes at least one of inverse conversion or rotation conversion.

### TECHNICAL FIELD

The present disclosure relates to an image encoding/decoding method and apparatus, and a recording medium for storing a bitstream, and more specifically, relates to an image encoding/decoding method and apparatus based on intra prediction, and a recording medium for storing a bitstream generated by the image encoding method/apparatus of the present disclosure.

### BACKGROUND ART

Recently, the demand for high-resolution and high-quality images, such as High Definition (HD) images and Ultra High Definition (UHD) images, has been increasing in various fields. As image data becomes high-resolution and high-quality, the amount of transmitted information or bit rate increases relative to conventional image data. The increase in transmitted information or bit rate amount leads to an increase in transmission costs and storage costs.

Accordingly, a high-efficiency image compression technology is required to effectively transmit, store, and reproduce the information of high-resolution and high-quality images.

### DISCLOSURE

### Technical Problem

The present disclosure is to provide an image encoding/decoding method and apparatus with improved encoding/decoding efficiency.

In addition, the present disclosure is to provide the image encoding/decoding method and apparatus for effectively performing intra prediction.

In addition, the present disclosure is to provide the image encoding/decoding method and apparatus for effectively performing intra template matching prediction (intraTMP).

In addition, the present disclosure is to provide the image encoding/decoding method and apparatus for performing flip transformation on a reference block used for intra template matching prediction and/or the template area of a reference block.

In addition, the present disclosure is to provide the image encoding/decoding method and apparatus for performing rotation transformation on a reference block used for intra template matching prediction and/or the template area of a reference block.

In addition, the present disclosure is to provide a non-transitory computer-readable recording medium for storing a bitstream generated by the image encoding method or apparatus according to the present disclosure.

In addition, the present disclosure is to provide a non-transitory computer-readable recording medium for storing a bitstream which is received and decoded by the image decoding apparatus according to the present disclosure and used for image reconstruction.

In addition, the present disclosure is to provide a method for transmitting a bitstream which is generated by the image encoding method or apparatus according to the present disclosure.

The technical problems to be achieved in the present disclosure are not limited to the technical problems described above, and other technical problems not described may be clearly understood by those of ordinary skill in the art from the following descriptions.

### Technical Solution

According to an embodiment of the present disclosure, as an image decoding method performed by an image decoding apparatus, the method includes obtaining transformation performance information representing whether transformation is performed, performing transformation on a predetermined first adjacent area adjacent to a reference block of a current block based on the transformation performance information, generating a first prediction block of the current block based on the first adjacent area where transformation is performed and a predetermined second adjacent area adjacent to the current block and generating a final prediction block of the current block by performing transformation on the first prediction block, wherein the first adjacent area is at a position corresponding to the second adjacent area, and the transformation may include at least one of flip transformation or rotation transformation.

According to an embodiment of the present disclosure, the first adjacent area may include at least one of a left adjacent area, a top adjacent area, a top-left adjacent area, a right adjacent area or a bottom adjacent area of the reference block.

According to an embodiment of the present disclosure, the transformation performance information may further include transformation type information representing a transformation type.

According to an embodiment of the present disclosure, the flip transformation may include at least one of vertical flip transformation, horizontal flip transformation, diagonal flip transformation or vertical diagonal flip transformation.

According to an embodiment of the present disclosure, the rotation transformation may include at least one of 90-degree counterclockwise rotation transformation, 180-degree counterclockwise rotation transformation or 270-degree counterclockwise rotation transformation.

According to an embodiment of the present disclosure, the first prediction block may be generated based on an error value calculated based on the first adjacent area where the transformation is performed and the second adjacent area.

According to an embodiment of the present disclosure, based on the current block being a non-square block, the first adjacent area may include a sample area within the reference block before the transform.

According to an embodiment of the present disclosure, generating the first prediction block may further include deriving an illumination compensation parameter based on the first adjacent area where the transformation is performed and the second adjacent area, performing illumination compensation on the reference block based on the illumination compensation parameter and generating the first prediction block based on a reference block where the illumination compensation is performed.

According to an embodiment of the present disclosure, the method further includes generating a second prediction block of the current block based on an intra prediction mode, wherein the final prediction block may be generated by weighted summing a first prediction block and a second prediction block where the transformation is performed.

According to an embodiment of the present disclosure, as an image encoding method performed by an image encoding apparatus, the method includes performing transformation on a predetermined first adjacent area adjacent to a reference block of a current block, generating a first prediction block of the current block based on the first adjacent area where transformation is performed and a predetermined second adjacent area adjacent to the current block, generating a final prediction block of the current block by performing transformation on the first prediction block and encoding transformation performance information representing whether the transformation is performed, wherein the first adjacent area is at a position corresponding to the second adjacent area, and the transformation may include at least one of flip transformation or rotation transformation.

According to an embodiment of the present disclosure, it may be a computer-readable recording medium storing a bitstream generated by an image encoding method.

According to an embodiment of the present disclosure, as a method for transmitting a bitstream generated by an image encoding method, the image encoding method includes performing transformation on a predetermined first adjacent area adjacent to a reference block of a current block, generating a first prediction block of the current block based on the first adjacent area where transformation is performed and a predetermined second adjacent area adjacent to the current block, generating a final prediction block of the current block by performing transformation on the first prediction block and encoding transformation performance information representing whether the transformation is performed, wherein the first adjacent area is at a position corresponding to the second adjacent area, and the transformation may include at least one of flip transformation or rotation transformation.

### Advantageous Effects

According to the present disclosure, an image encoding/decoding method and apparatus with improved encoding/decoding efficiency may be provided.

In addition, according to the present disclosure, an image encoding/decoding method and apparatus for effectively performing intra prediction may be provided.

In addition, according to the present disclosure, an image encoding/decoding method and apparatus for effectively performing intra template matching prediction (intraTMP) may be provided.

In addition, according to the present disclosure, an image encoding/decoding method and apparatus for performing flip transformation on a reference block used for intra template matching prediction and/or the template area of a reference block may be provided.

In addition, according to the present disclosure, an image encoding/decoding method and apparatus for performing rotation transformation on a reference block used for intra template matching prediction and/or the template area of a reference block may be provided.

In addition, according to the present disclosure, a non-transitory computer-readable recording medium for storing a bitstream generated by the image encoding method or apparatus according to the present disclosure may be provided.

According to the present disclosure, a non-transitory computer-readable recording medium for storing a bitstream which is received and decoded by the image decoding apparatus according to the present disclosure and used for image reconstruction may be provided.

In addition, according to the present disclosure, a method for transmitting a bitstream which is generated by an image encoding method or apparatus according to the present disclosure may be provided.

The effects obtainable from the present disclosure are not limited to the effects described above, and other effects not described may be clearly understood by those of ordinary skill in the art from the following descriptions.

### DESCRIPTION OF DRAWINGS

FIG. 1 shows a schematic diagram of a video coding system to which an embodiment according to the present disclosure may be applied.

FIG. 2 shows a schematic diagram of an image encoding apparatus to which an embodiment according to the present disclosure may be applied.

FIG. 3 shows a schematic diagram of an image decoding apparatus to which an embodiment according to the present disclosure may be applied.

FIG. 4 is a flowchart illustrating an intra prediction-based video/image encoding method.

FIG. 5 shows an exemplary diagram of the configuration of an intra predictor according to the present disclosure.

FIG. 6 is a flowchart illustrating an intra prediction-based video/image decoding method.

FIG. 7 shows an exemplary diagram of the configuration of an intra predictor according to the present disclosure.

FIG. 8 is a diagram illustrating a template area used in a template-based intra mode derivation (TIMD) mode according to the present disclosure.

FIG. 9 is a diagram for describing a template matching-based encoding/decoding method according to the present disclosure.

FIG. 10 is a diagram illustrating a search area used for intra template matching prediction (intraTMP) according to an embodiment of the present disclosure.

FIGS. 11 and 12 are intra template matching prediction flowcharts according to an embodiment of the present disclosure.

FIGS. 13 and 14 are diagrams illustrating template areas of a current block and a reference block according to an embodiment of the present disclosure.

FIG. 15 is a diagram in which vertical flip transformation is applied to a reference block and the template area of a reference block according to an embodiment of the present disclosure.

FIG. 16 is a diagram in which horizontal flip transformation is applied to a reference block and the template area of a reference block according to an embodiment of the present disclosure.

FIG. 17 is a diagram in which diagonal flip transformation is applied to a reference block and the template area of a reference block according to an embodiment of the present disclosure.

FIG. 18 is a diagram in which vertical diagonal flip transformation is applied to a reference block and the template area of a reference block according to an embodiment of the present disclosure.

FIG. 19 is a diagram in which 90-degree counterclockwise rotation transformation is applied to a reference block and the template block of a reference area according to an embodiment of the present disclosure.

FIG. 20 is a diagram in which 180-degree counterclockwise rotation transformation is applied to a reference area and the template area of a reference area according to an embodiment of the present disclosure.

FIG. 21 is a diagram in which 270-degree counterclockwise rotation transformation is applied to a reference area and the template area of a reference area according to an embodiment of the present disclosure.

FIG. 22 is a diagram illustrating a reference block and a template area when a current block is a rectangle according to an embodiment of the present disclosure.

FIG. 23 is a diagram in which vertical flip transformation is applied to a reference block and the template area of a reference block when a current block is a rectangular block according to an embodiment of the present disclosure.

FIG. 24 is a diagram in which horizontal flip transformation is applied to a reference block and the template area of a reference block when a current block is a rectangular block according to an embodiment of the present disclosure.

FIG. 25 is a diagram in which diagonal flip transformation is applied to a reference block and the template area of a reference block when a current block is a rectangular block according to an embodiment of the present disclosure.

FIG. 26 is a diagram in which vertical diagonal flip transformation is applied to a reference block and the template area of a reference block when a current block is a rectangular block according to an embodiment of the present disclosure.

FIG. 27 is a diagram in which vertical 90-degree rotation transformation is applied to a reference block and the template area of a reference block when a current block is a rectangular block according to an embodiment of the present disclosure.

FIG. 28 is a diagram in which vertical 180-degree rotation transformation is applied to a reference area and the template area of a reference area when a current block is a rectangular block according to an embodiment of the present disclosure.

FIG. 29 is a diagram in which vertical 270-degree rotation transformation is applied to a reference area and the template area of a reference area when a current block is a rectangular block according to an embodiment of the present disclosure.

FIG. 30 is a diagram illustrating a reference block and the template area of a reference block when a current block is a non-square block according to an embodiment of the present disclosure.

FIG. 31 is a diagram illustrating a reference block and the template area of a reference block when a current block is a non-square block according to an embodiment of the present disclosure.

FIG. 32 is a diagram illustrating a reference block and the template area of a reference block when a current block is a non-square block according to an embodiment of the present disclosure.

FIG. 33 is a diagram illustrating template areas of a current block and a reference block according to an embodiment of the present disclosure.

FIG. 34 is a diagram illustrating a prediction error calculation method between a reference block and a current block according to an embodiment of the present disclosure.

FIG. 35 is a diagram illustrating a prediction error calculation method between a flip-transformed reference block and a current block according to an embodiment of the present disclosure.

FIG. 36 is a diagram illustrating a prediction error calculation method between a rotation-transformed reference block and a current block according to an embodiment of the present disclosure.

FIGS. 37 to 39 are flowcharts of a method for determining whether to perform transformation according to an embodiment of the present disclosure.

FIGS. 40 and 41 are diagrams illustrating an illumination compensation performance method according to an embodiment of the present disclosure.

FIGS. 42 and 43 are diagrams illustrating a method for generating a final prediction block by weighted summing multiple prediction blocks according to an embodiment of the present disclosure.

FIG. 44 is a flowchart representing an encoding method according to the present disclosure.

FIG. 45 is a flowchart representing a decoding method according to the present disclosure.

FIG. 46 shows an exemplary diagram of a content streaming system to which an embodiment of the present disclosure may be applied.

### MODE FOR INVENTION

Hereinafter, embodiments of the present disclosure will be described in detail by referring to the attached drawings for those of ordinary skill in the art to easily implement them. However, the present disclosure may be implemented in various different forms and is not limited to the embodiments described herein.

In describing embodiments of the present disclosure, detailed explanations of well-known configurations or functions are omitted when they are deemed to obscure the main point of the present disclosure. Additionally, parts irrelevant to the description of the present disclosure are omitted from the drawings, and similar reference numerals have been assigned to similar parts.

In the present disclosure, when a certain component is described as being “connected,” “coupled,” or “linked” to another component, this may include not only a direct connection but also an indirect connection where another component may exist in the middle. Additionally, when a certain component is described as “including” or “having” another component, this means that, unless explicitly stated otherwise, it does not exclude other components but may further include additional components.

In the present disclosure, the terms first, second, etc. are used solely for the purpose of distinguishing one component from another and do not limit the order or importance of the components unless explicitly stated otherwise. Accordingly, a first component in one embodiment may be referred to as a second component in another embodiment, and similarly, a second component in one embodiment may be referred to as a first component in another embodiment within the range of the present disclosure.

In the present disclosure, distinguishable components are described to clearly explain their respective characteristics and do not necessarily mean that the components are separate. In other words, a plurality of components may be integrated into a single hardware or software unit, or a single component may be distributed across multiple hardware or software units.

Accordingly, without explicitly describing them, such integrated or distributed embodiments are also included in the range of the present disclosure.

In the present disclosure, the components described in various embodiments do not necessarily mean essential components, and some may be optional components. Accordingly, embodiments composed of a subset of the components described in one embodiment are also included in the range of the present disclosure. Additionally, embodiments that include additional components beyond those described in various embodiments are also included in the range of the present disclosure.

The present disclosure relates to the encoding and decoding of images, and the terms used herein may have the ordinary meanings commonly used in the field of technology to which this disclosure belongs unless the terms are newly defined in the present disclosure.

In the present disclosure, “video” may mean a set of images over time.

In the present disclosure, “picture” generally refers to a unit representing a single image at a specific point in time. A slice/tile is an encoding unit that constitutes a part of a picture, and a picture may be composed of one or more slices/tiles. Additionally, a slice/tile may include one or more coding tree units (CTUs).

In the present disclosure, “pixel” or “pel” may refer to the smallest unit that constitutes one picture (or image). Additionally, the term “sample” may be used as a corresponding term for a pixel. A sample may generally represent a pixel or the value of a pixel and may indicate only the pixel/pixel value of a luma component or only the pixel/pixel value of a chroma component.

In the present disclosure, “unit” may refer to a basic unit of image processing. A unit may include at least one of a specific area of a picture or information related to the area. Depending on the context, the term “unit” may be used interchangeably with “sample array,” “block,” “area,” etc. In general, an M×N block may include a set (or array) of samples (or a sample array) or a set (or array) of transform coefficients, consisting of M columns and N rows.

In the present disclosure, the term “current block” may refer to one of “current coding block”, “current coding unit”, “encoding target block”, “decoding target block”, or “processing target block”. When prediction is performed, “current block” may refer to “current prediction block” or “prediction target block”. When transform (inverse transform)/quantization (dequantization) is performed, “current block” may refer to “current transform block” or “transform target block”. When filtering is performed, “current block” may refer to “filtering target block”.

In the present disclosure, unless explicitly stated as a chroma block, the term “current block” may refer to a block that includes both a luma component block and a chroma component block or may refer to “the luma block of the current block”. The luma component block of the current block may be explicitly expressed with terms such as “luma block” or “current luma block”, clearly indicating it as a luma component block. Additionally, the chroma component block of the current block may be explicitly expressed with terms such as “chroma block” or “current chroma block”, clearly indicating it as a chroma component block.

In the present disclosure, “/” and “,” may refer to “and/or”. For example, “A/B” and “A, B” may refer to “A and/or B”. Additionally, “A/B/C” and “A, B, C” may refer to “at least one of A, B, and/or C”.

In the present disclosure, “or” may refer to “and/or”. For example, “A or B” may mean 1) “A” only, 2) “B” only, or 3) “A and B.” Alternatively, in the present disclosure, “or” may also mean “additionally or alternatively”.

In the present disclosure, “at least one of A, B and C” may mean “only A,” “only B,” “only C,” or “any combination of A, B and C.” In addition, “at least one of A, B or C” or “at least one of A, B and/or C” may mean “at least one of A, B and C.”

Parentheses used in the present disclosure may mean “for example.” For example, when indicated as “prediction (intra prediction)”, “intra prediction” may be proposed as an example of “prediction”. In other words, “prediction” in the present disclosure is not limited to “intra prediction”, and “intra prediction” may be proposed as an example of “prediction”. In addition, even when indicated as “prediction (intra prediction)”, “intra prediction” may be proposed as an example of “prediction”.

### Overview of the Video Coding System

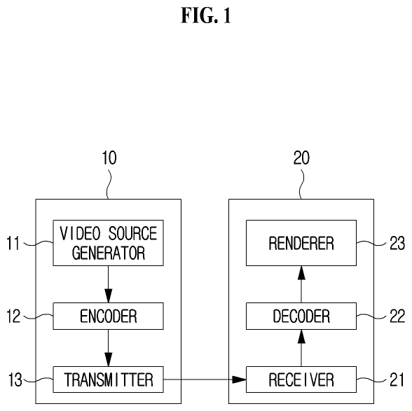

FIG. 1 shows a schematic diagram of a video coding system to which an embodiment according to the present disclosure may be applied.

A video coding system according to an embodiment may include an encoder apparatus 10 and a decoder apparatus 20. The encoder apparatus 10 may transmit encoded video and/or image information or data to the decoder apparatus 20 through a digital storage medium or network in the form of a file or streaming.

An encoder apparatus 10 according to an embodiment may include a video source generator 11, an encoder 12, and a transmitter 13. A decoder apparatus 20 according to an embodiment may include a receiver 21, a decoder 22, and a renderer 23. The encoder 12 may be referred to as a video/image encoder, and the decoder 22 may be referred to as a video/image decoder. The transmitter 13 may be included in the encoder 12. The receiver 21 may be included in the decoder 22. The renderer 23 may include a display, and the display may be configured as a separate device or external component.

The video source generator 11 may obtain a video/an image through a process of capturing, synthesizing, or generating a video/an image. The video source generator 11 may include a video/an image capture device and/or a video/an image generation device. The video/image capture device may include, for example, one or more cameras, a video/an image archive containing previously captured video/image, etc. The video/image generation device includes, for example, a computer, tablet, or smartphone, and may (electronically) generate a video/an image. For example, virtual video/image may be generated through a computer, etc., and in this case, the video/image capturing process may be replaced by the process of generating related data.

The encoder 12 may encode the input video/image. The encoder 12 may perform a series of procedures such as prediction, transform, quantization, etc. for compression and encoding efficiency. The encoder 12 may output the encoded data (encoded video/image information) in the form of a bitstream.

The transmitter 13 may obtain the encoded video/image information or data output in the form of a bitstream and transmit it to the receiver 21 of the decoder apparatus 20 or another external object through a digital storage medium or network, in the form of a file or streaming. The digital storage medium may include various storage media such as USB, SD, CD, DVD, Blu-ray, HDD, SSD, etc. The transmitter 13 may include an element for generating media files through a predetermined file format and element for transmission over broadcast/communication networks. The transmitter 13 may be provided as a separate transmission apparatus from the encoder 120, in which case the transmission apparatus may include at least one processor for obtaining the encoded video/image information or data in bitstream form and a transmitter for delivering it in the form of file or streaming. This receiver 21 may extract/receive the bitstream from the storage medium or network and transmit it to decoder 22.

The decoder 22 may decode the video/image by performing a series of procedures such as dequantization, inverse transform, prediction, etc. corresponding to the operations of the encoder 12.

The renderer 23 may render the decoded video/image. The rendered video/image may be displayed through the display unit.

### Overview of the Image Encoding Apparatus

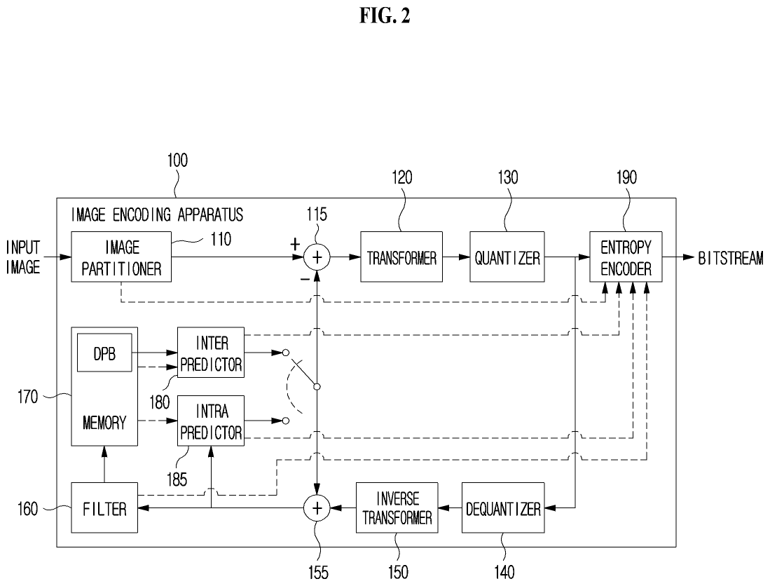

FIG. 2 shows a schematic diagram of an image encoding apparatus to which an embodiment according to the present disclosure may be applied.

As described in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185, and an entropy encoder 190. The inter predictor 180 and the intra predictor 185 may collectively be referred to as a “predictor.” The transformer 120, the quantizer 130, the dequantizer 140, and the inverse transformer 150 may be included in a residual processor. The residual processor may further include the subtractor 115.

All or at least some of the multiple components constituting the image encoding apparatus 100 may be implemented as a single hardware component (i.e., an encoder or a processor), depending on the embodiment. Additionally, the memory 170 may include a decoded picture buffer (DPB) and may be implemented by a digital storage medium.

The image partitioner 110 may partition the input image (or picture, frame) input to the image encoding apparatus 100 into at least one processing unit. As an example, the processing unit may be referred to as a coding unit (CU). A coding unit may be obtained by recursively partitioning a coding tree unit (CTU) or a largest coding unit (LCU) according to a quad-tree, binary-tree, or ternary-tree (QT/BT/TT) structure. For example, a coding unit may be divided into a deeper-depth coding unit based on a quad-tree structure, a binary-tree structure, and/or a ternary-tree structure. For partitioning a coding unit, the quad-tree structure may be applied first, followed by the binary-tree structure and/or the ternary-tree structure. The coding procedure according to the present disclosure may be performed based on the final coding unit, which is not further partitioned. The largest coding unit may be used directly as the final coding unit, or a deeper-depth coding unit obtained by partitioning the largest coding unit may be used as the final coding unit. Here, the coding procedure may include a procedure such as prediction, transform, and/or reconstruction, which will be described later. As another example, the processing unit for the coding procedure may be a prediction unit (PU) or a transform unit (TU). The prediction unit and the transform unit may each be divided or partitioned from the final coding unit. The prediction unit may be a unit for sample prediction, and the transform unit may be a unit for deriving a transform coefficient and/or deriving a residual signal from a transform coefficient.

The predictor (inter predictor 180 or intra predictor 185) may perform prediction for a target block (current block) and generate a predicted block that includes prediction samples for the current block. The predictor may determine whether intra prediction or inter prediction is applied to the current block or coding unit (CU). The predictor may generate various information related to the prediction of the current block and transmit it to the entropy encoder 190. The prediction-related information may be encoded by the entropy encoder 190 and may be output in the form of a bitstream.

The intra predictor 185 may predict the current block by referring to samples within the current picture. The referenced samples may be located in the neighboring area of the current block or may be located farther away, depending on the intra prediction mode and/or intra prediction method. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes, depending on the granularity of the prediction direction. However, this is an example, and a greater or fewer number of directional prediction modes may be used depending on the configuration. The intra predictor 185 may also determine the prediction mode applied to the current block by using the prediction mode applied to neighboring block.

The inter predictor 180 may derive a predicted block for the current block based on a reference block (reference sample array) specified by a motion vector on a reference picture. To reduce the amount of motion information transmitted in the inter prediction mode, motion information may be predicted at the block, sub-block, or sample level based on the correlation of motion information between the neighboring block and the current block. The motion information may include a motion vector and a reference picture index. The motion information may further include information on the inter prediction direction (i.e. L0 prediction, L1 prediction, Bi prediction, etc.). In inter prediction, neighboring block may include spatial neighboring block present within the current picture and temporal neighboring block present in the reference picture. The reference picture containing the reference block and the reference picture containing the temporal neighboring block may be the same or different. The temporal neighboring block may be referred to as a collocated reference block or a collocated coding unit (colCU). The reference picture containing the temporal neighboring block may be referred to as a collocated picture (colPic). For example, the inter predictor 180 may construct a motion information candidate list based on neighboring blocks and generate information indicating which candidate is used to derive the motion vector and/or reference picture index of the current block. Inter prediction may be performed based on various prediction modes, and for example, in the skip mode and merge mode, the inter predictor 180 may use the motion information of neighboring block as the motion information of the current block. In skip mode, unlike merge mode, residual signal may not be transmitted. In the motion vector prediction (MVP) mode, the motion vector of a neighboring block may be used as a motion vector predictor, and the motion vector of the current block may be signaled by encoding the motion vector difference and an indicator for the motion vector predictor. The motion vector difference may refer to the difference between the motion vector of the current block and the motion vector predictor.

The predictor may generate a prediction signal based on various prediction methods and/or prediction techniques described later. For example, the predictor may apply intra prediction or inter prediction for the prediction of the current block, and it may also apply both intra prediction and inter prediction simultaneously. The prediction method that applies intra prediction and inter prediction simultaneously for the prediction of the current block may be referred to as combined inter and intra prediction (CIIP). Additionally, the predictor may perform intra block copy (IBC) for the prediction of the current block. Intra block copy may be used, for example, for screen content coding (SCC), etc. in applications such as game content image/video coding. IBC is a method of predicting the current block by using a pre-reconstructed reference block within the current picture, located at a predetermined distance from the current block. When IBC is applied, the position of the reference block within the current picture may be encoded as a vector (block vector) corresponding to the predetermined distance. IBC basically performs prediction within the current picture, but since it derives a reference block within the current picture, it may operate similarly to inter prediction. In other words, IBC may use at least one of the inter prediction methods described in the present disclosure.

The prediction signal generated by the predictor may be used to generate a reconstructed signal or to generate a residual signal. The subtractor 115 may generate a residual signal (residual block, residual sample array) by subtracting the prediction signal (predicted block, predicted sample array) output from the predictor from the input image signal (original block, original sample array). The generated residual signal may be transmitted to the transformer 120.

The transformer 120 may generate transform coefficients by applying a transform method to the residual signal. For example, the transform method may include at least one of Discrete Cosine Transform (DCT), Discrete Sine Transform (DST), Karhunen-Loeve Transform (KLT), Graph-Based Transform (GBT), or Conditionally Non-linear Transform (CNT). Here, GBT refers to a transform obtained from a graph when the relationship information between pixels is represented as a graph. CNT refers to a transform obtained based on a prediction signal generated by using all previously reconstructed pixels. The transform process may be applied to a pixel block of the same square size or to a non-square variable-sized block.

The quantizer 130 may quantize the transform coefficients and transmit them to the entropy encoder 190. The entropy encoder 190 may encode the quantized signal (information on the quantized transform coefficients) and output it as a bitstream. The information on the quantized transform coefficients may be referred to as residual information. The quantizer 130 may rearrange the block-shaped quantized transform coefficients into a one-dimensional vector based on a coefficient scan order and may generate the information on the quantized transform coefficients based on the one-dimensional vector of quantized transform coefficients.

The entropy encoder 190 may perform various encoding methods, such as exponential Golomb, context-adaptive variable length coding (CAVLC), or context-adaptive binary arithmetic coding (CABAC). The entropy encoder 190 may encode not only the quantized transform coefficients but also information necessary for video/image reconstruction (i.e., values of syntax elements) either together or separately with the quantized transform coefficients. The encoded information (i.e., encoded video/image information) may be transmitted or stored in the form of a bitstream in network abstraction layer (NAL) unit. The video/image information may further include information on various parameter sets, such as an adaptation parameter set (APS), a picture parameter set (PPS), a sequence parameter set (SPS), or a video parameter set (VPS). Additionally, the video/image information may further include general constraint information. The signaling information, transmitted information, and/or syntax elements described in the present disclosure may be included in the bitstream by being encoded through the above-described encoding process.

The bitstream may be transmitted through a network or stored in a digital storage medium. Here, the network may include a broadcast network and/or a communication network, etc., and the digital storage medium may include various storage media such as USB, SD, CD, DVD, Blu-ray, HDD, SSD, etc. A transmitter (not shown) for transmitting the signal output from the entropy encoder 190 and/or a storage unit (not shown) for storing the signal may be provided as an internal/external element of the image encoding apparatus 100, or the transmitter may be configured as a component of the entropy encoder 190.

The quantized transform coefficients output from the quantizer 130 may be used to generate a residual signal. For example, a residual signal (residual block or residual samples) may be reconstructed by applying dequantization and inverse transform to the quantized transform coefficients through the dequantizer 140 and the inverse transformer 150.

The adder 155 may generate a reconstructed signal (reconstructed picture, reconstructed block, or reconstructed sample array) by adding the reconstructed residual signal to the prediction signal output from the inter predictor 180 or the intra predictor 185. When there is no residual for the target block, such as when the skip mode is applied, the predicted block may be used as the reconstructed block. The adder 155 may be referred to as a reconstructor or a reconstructed block generator. The generated reconstructed signal may be used for intra prediction of the next target block within the current picture and, as described later, may also be used for inter prediction of the next picture after undergoing filtering.

Meanwhile, luma mapping with chroma scaling (LMCS) may be applied during picture encoding and/or reconstruction processes.

The filter 160 may apply filtering to the reconstructed signal to enhance subjective/objective quality. For example, the filter 160 may apply various filtering methods to the reconstructed picture to generate a modified reconstructed picture, and the modified reconstructed picture may be stored in the memory 170, specifically in the DPB of the memory 170. The various filtering methods may include, for example, deblocking filtering, sample adaptive offset, adaptive loop filter, bilateral filter, etc. The filter 160 may generate various filtering-related information, as described later in the explanations of each filtering method, and may transmit it to the entropy encoder 190. The filtering-related information may be encoded by the entropy encoder 190 and output in the form of a bitstream.

The modified reconstructed picture transmitted to the memory 170 may be used as a reference picture in the inter predictor 180. When inter prediction is applied in this case, the image encoding apparatus 100 may avoid prediction mismatches between the image encoding apparatus 100 and the image decoding apparatus, and may improve encoding efficiency.

The DPB in the memory 170 may store the modified reconstructed picture for use as a reference picture in the inter predictor 180. The memory 170 may store the motion information of a block in the current picture where motion information has been derived (or encoded) and/or the motion information of blocks in already reconstructed pictures. The stored motion information may be transmitted to the inter predictor 180 for use as motion information of spatial neighboring block or temporal neighboring block. The memory 170 may store the reconstructed samples of reconstructed blocks in the current picture and transmit them to the intra predictor 185.

### Overview of the Image Decoding Apparatus

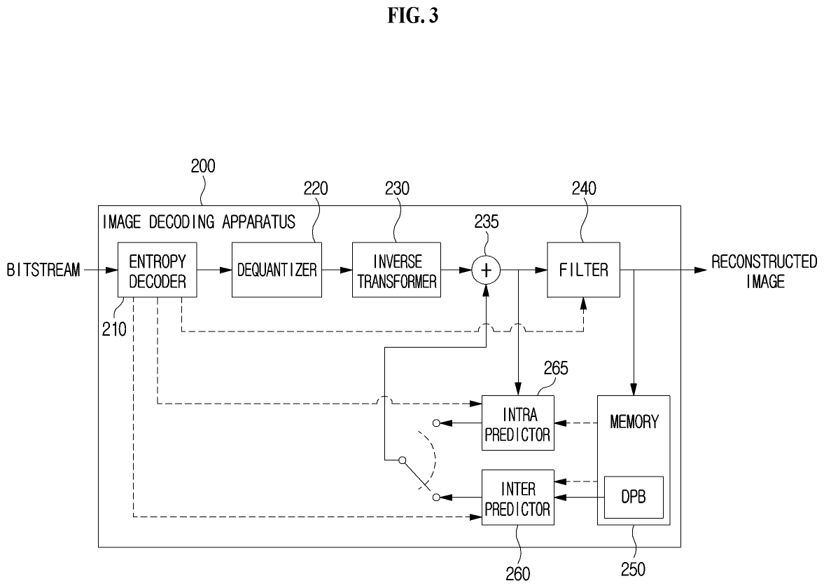

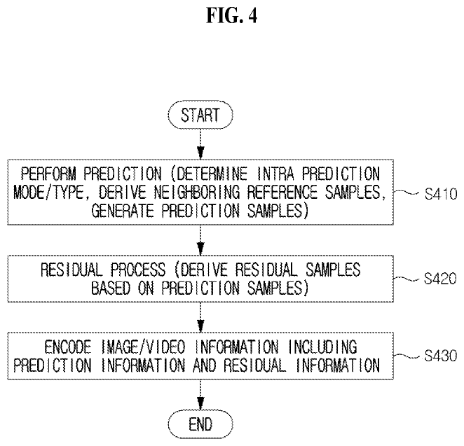

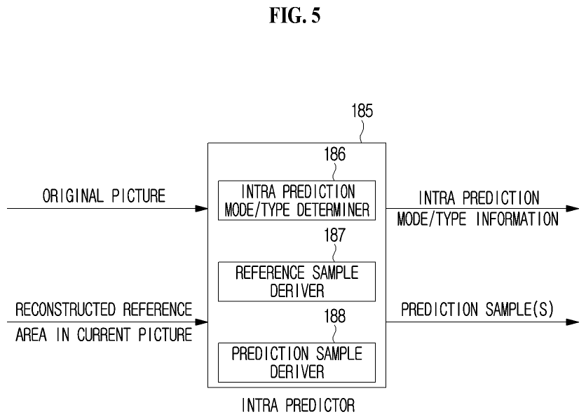

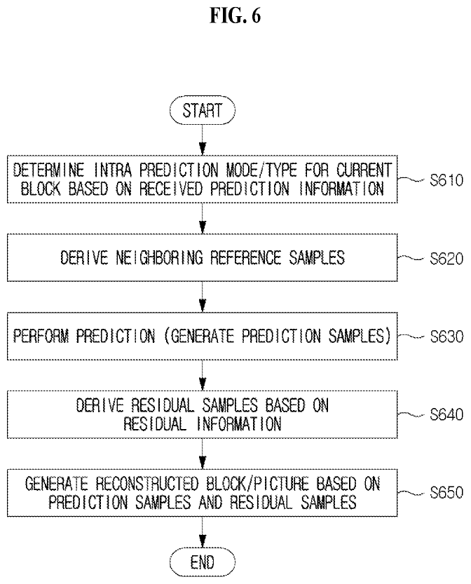

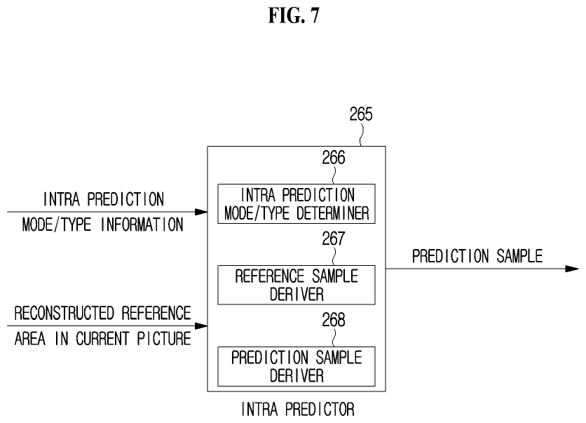

FIG. 3 shows a schematic diagram of an image decoding apparatus to which an embodiment according to the present disclosure may be applied.

As shown in FIG. 3, the image decoding apparatus 200 may include an entropy decoder 210, a dequantizer 220, an inverse transformer 230, an adder 235, a filter 240, a memory 250, an inter predictor 260, and an intra predictor 265. The inter predictor 260 and the intra predictor 265 may collectively be referred to as a “predictor”. The dequantizer 220 and the inverse transformer 230 may be included in a residual processor.

All or at least some of the multiple components constituting the image decoding apparatus 200 may be implemented as a single hardware component (i.e., a decoder or a processor), depending on the embodiment. Additionally, the memory 170 may include a DPB and may be implemented by a digital storage medium.

The image decoding apparatus 200, which receives a bitstream containing video/image information, may perform a process corresponding to the process performed by the image encoding apparatus 100 in FIG. 2 to reconstruct the image. For example, the image decoding apparatus 200 may perform decoding using the processing unit applied in the image encoding apparatus. Therefore, the processing unit for decoding may be, for example, a coding unit. The coding unit may be a coding tree unit or may be obtained by splitting a largest coding unit. Additionally, the reconstructed image signal decoded and output through the image decoding apparatus 200 may be played back through a playback device (not shown).

The image decoding apparatus 200 may receive a signal output from the image encoding apparatus in FIG. 2 in the form of a bitstream. The received signal may be decoded through the entropy decoder 210. For example, the entropy decoder 210 may parse the bitstream to extract the information necessary for image reconstruction (or picture reconstruction) (i.e., video/image information). The video/image information may further include information on various parameter sets, such as an adaptation parameter set (APS), a picture parameter set (PPS), a sequence parameter set (SPS), or a video parameter set (VPS). Additionally, the video/image information may further include general constraint information. The image decoding apparatus may additionally use information on the parameter set and/or the general constraint information to decode the image. The signaling information, received information, and/or syntax elements described in the present disclosure may be obtained from the bitstream by being decoded through the decoding process. For example, the entropy decoder 210 may decode the information in the bitstream based on coding methods such as exponential Golomb encoding, CAVLC, or CABAC, and may output a syntax element value necessary for image reconstruction and quantized values of a transform coefficient related to a residual. More specifically, the CABAC entropy decoding method may receive a bin corresponding to a syntax element in the bitstream, may determine a context model using the information of the decoding target syntax element, the decoding information of neighboring block and the decoding target block, or information of previously decoded symbol/bin, may predict the probability of bin occurrence according to the determined context model, and may perform arithmetic decoding of the bin to generate a symbol corresponding to each syntax element. In this case, the CABAC entropy decoding method may update the context model for the next symbol/bin context model using the decoded symbol/bin information after determining the context model. Among the decoded information from the entropy decoder 210, the prediction-related information may be provided to the predictor (inter predictor 260 and intra predictor 265), and the residual value which is entropy decoded by the entropy decoder 210, in other words, the quantized transform coefficients and related parameter information, may be input to the dequantizer 220. Additionally, among the decoded information from the entropy decoder 210, filtering-related information may be provided to the filter 240. Meanwhile, a receiver (not shown) that receives the signal output from the image encoding apparatus may be additionally configured as an internal/external element of the image decoding apparatus 200, or the receiver may be configured as a component of the entropy decoder 210.

Meanwhile, the image decoding apparatus according to the present disclosure may also be referred to as a video/image/picture decoding apparatus. The image decoding apparatus may include an information decoder (video/image/picture information decoder) and/or a sample decoder (video/image/picture sample decoder). The information decoder may include the entropy decoder 210, and the sample decoder may include at least one of the dequantizer 220, the inverse transformer 230, the adder 235, the filter 240, the memory 250, the inter predictor 260, or the intra predictor 265.

In the present disclosure, “or” may refer to “and/or”. For example, “A or B” may mean 1) “A” only, 2) “B” only, or 3) “A and B.” Alternatively, in the present disclosure, “or” may also mean “additionally or alternatively”.

In the present disclosure, “at least one of A, B and C” may mean “only A,” “only B,” “only C,” or “any combination of A, B and C.” In addition, “at least one of A, B or C” or “at least one of A, B and/or C” may mean “at least one of A, B and C.”

Parentheses used in the present disclosure may mean “for example.” For example, when indicated as “prediction (intra prediction)”, “intra prediction” may be proposed as an example of “prediction”. In other words, “prediction” in the present disclosure is not limited to “intra prediction”, and “intra prediction” may be proposed as an example of “prediction”. In addition, even when indicated as “prediction (intra prediction)”, “intra prediction” may be proposed as an example of “prediction”.

### Overview of the Video Coding System

FIG. 1 shows a schematic diagram of a video coding system to which an embodiment according to the present disclosure may be applied.

A video coding system according to an embodiment may include an encoder apparatus 10 and a decoder apparatus 20. The encoder apparatus 10 may transmit encoded video and/or image information or data to the decoder apparatus 20 through a digital storage medium or network in the form of a file or streaming.

An encoder apparatus 10 according to an embodiment may include a video source generator 11, an encoder 12, and a transmitter 13. A decoder apparatus 20 according to an embodiment may include a receiver 21, a decoder 22, and a renderer 23. The encoder 12 may be referred to as a video/image encoder, and the decoder 22 may be referred to as a video/image decoder. The transmitter 13 may be included in the encoder 12. The receiver 21 may be included in the decoder 22. The renderer 23 may include a display, and the display may be configured as a separate device or external component.

The video source generator 11 may obtain a video/an image through a process of capturing, synthesizing, or generating a video/an image. The video source generator 11 may include a video/an image capture device and/or a video/an image generation device. The video/image capture device may include, for example, one or more cameras, a video/an image archive containing previously captured video/image, etc. The video/image generation device includes, for example, a computer, tablet, or smartphone, and may (electronically) generate a video/an image. For example, virtual video/image may be generated through a computer, etc., and in this case, the video/image capturing process may be replaced by the process of generating related data.

The encoder 12 may encode the input video/image. The encoder 12 may perform a series of procedures such as prediction, transform, quantization, etc. for compression and encoding efficiency. The encoder 12 may output the encoded data (encoded video/image information) in the form of a bitstream.

The transmitter 13 may obtain the encoded video/image information or data output in the form of a bitstream and transmit it to the receiver 21 of the decoder apparatus 20 or another external object through a digital storage medium or network, in the form of a file or streaming. The digital storage medium may include various storage media such as USB, SD, CD, DVD, Blu-ray, HDD, SSD, etc. The transmitter 13 may include an element for generating media files through a predetermined file format and element for transmission over broadcast/communication networks. The transmitter 13 may be provided as a separate transmission apparatus from the encoding apparatus 12, in which case the transmission apparatus may include at least one processor for obtaining the encoded video/image information or data in bitstream form and a transmitter for delivering it in the form of file or streaming. The receiver 21 may extract/receive the bitstream from the storage medium or network and transmit it to decoder 22.

The decoder 22 may decode the video/image by performing a series of procedures such as dequantization, inverse transform, prediction, etc. corresponding to the operations of the encoder 12.

The renderer 23 may render the decoded video/image. The rendered video/image may be displayed through the display unit.

### Overview of the Image Encoding Apparatus

FIG. 2 shows a schematic diagram of an image encoding apparatus to which an embodiment according to the present disclosure may be applied.

As described in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185, and an entropy encoder 190. The inter predictor 180 and the intra predictor 185 may collectively be referred to as a “predictor.” The transformer 120, the quantizer 130, the dequantizer 140, and the inverse transformer 150 may be included in a residual processor. The residual processor may further include the subtractor 115.

All or at least some of the multiple components constituting the image encoding apparatus 100 may be implemented as a single hardware component (i.e., an encoder or a processor), depending on the embodiment. Additionally, the memory 170 may include a decoded picture buffer (DPB) and may be implemented by a digital storage medium.

The image partitioner 110 may partition the input image (or picture, frame) input to the image encoding apparatus 100 into at least one processing unit. As an example, the processing unit may be referred to as a coding unit (CU). A coding unit may be obtained by recursively partitioning a coding tree unit (CTU) or a largest coding unit (LCU) according to a quad-tree, binary-tree, or ternary-tree (QT/BT/TT) structure. For example, a coding unit may be divided into a deeper-depth coding unit based on a quad-tree structure, a binary-tree structure, and/or a ternary-tree structure. For partitioning a coding unit, the quad-tree structure may be applied first, followed by the binary-tree structure and/or the ternary-tree structure. The coding procedure according to the present disclosure may be performed based on the final coding unit, which is not further partitioned. The largest coding unit may be used directly as the final coding unit, or a deeper-depth coding unit obtained by partitioning the largest coding unit may be used as the final coding unit. Here, the coding procedure may include a procedure such as prediction, transform, and/or reconstruction, which will be described later. As another example, the processing unit for the coding procedure may be a prediction unit (PU) or a transform unit (TU). The prediction unit and the transform unit may each be divided or partitioned from the final coding unit. The prediction unit may be a unit for sample prediction, and the transform unit may be a unit for deriving a transform coefficient and/or deriving a residual signal from a transform coefficient.

The predictor (inter predictor 180 or intra predictor 185) may perform prediction for a target block (current block) and generate a predicted block that includes prediction samples for the current block. The predictor may determine whether intra prediction or inter prediction is applied to the current block or coding unit (CU). The predictor may generate various information related to the prediction of the current block and transmit it to the entropy encoder 190. The prediction-related information may be encoded by the entropy encoder 190 and may be output in the form of a bitstream.

The intra predictor 185 may predict the current block by referring to samples within the current picture. The referenced samples may be located in the neighboring area of the current block or may be located farther away, depending on the intra prediction mode and/or intra prediction method. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes, depending on the granularity of the prediction direction. However, this is an example, and a greater or fewer number of directional prediction modes may be used depending on the configuration. The intra predictor 185 may also determine the prediction mode applied to the current block by using the prediction mode applied to neighboring block.

The inter predictor 180 may derive a predicted block for the current block based on a reference block (reference sample array) specified by a motion vector on a reference picture. To reduce the amount of motion information transmitted in the inter prediction mode, motion information may be predicted at the block, sub-block, or sample level based on the correlation of motion information between the neighboring block and the current block. The motion information may include a motion vector and a reference picture index. The motion information may further include information on the inter prediction direction (i.e. L0 prediction, L1 prediction, Bi prediction, etc.). In inter prediction, neighboring block may include spatial neighboring block present within the current picture and temporal neighboring block present in the reference picture. The reference picture containing the reference block and the reference picture containing the temporal neighboring block may be the same or different. The temporal neighboring block may be referred to as a collocated reference block or a collocated coding unit (colCU). The reference picture containing the temporal neighboring block may be referred to as a collocated picture (colPic). For example, the inter predictor 180 may construct a motion information candidate list based on neighboring blocks and generate information indicating which candidate is used to derive the motion vector and/or reference picture index of the current block. Inter prediction may be performed based on various prediction modes, and for example, in the skip mode and merge mode, the inter predictor 180 may use the motion information of neighboring block as the motion information of the current block. In skip mode, unlike merge mode, residual signal may not be transmitted. In the motion vector prediction (MVP) mode, the motion vector of a neighboring block may be used as a motion vector predictor, and the motion vector of the current block may be signaled by encoding the motion vector difference and an indicator for the motion vector predictor. The motion vector difference may refer to the difference between the motion vector of the current block and the motion vector predictor.

The predictor may generate a prediction signal based on various prediction methods and/or prediction techniques described later. For example, the predictor may apply intra prediction or inter prediction for the prediction of the current block, and it may also apply both intra prediction and inter prediction simultaneously. The prediction method that applies intra prediction and inter prediction simultaneously for the prediction of the current block may be referred to as combined inter and intra prediction (CIIP). Additionally, the predictor may perform intra block copy (IBC) for the prediction of the current block. Intra block copy may be used, for example, for screen content coding (SCC), etc. in applications such as game content image/video coding. IBC is a method of predicting the current block by using a pre-reconstructed reference block within the current picture, located at a predetermined distance from the current block. When IBC is applied, the position of the reference block within the current picture may be encoded as a vector (block vector) corresponding to the predetermined distance. IBC basically performs prediction within the current picture, but since it derives a reference block within the current picture, it may operate similarly to inter prediction. In other words, IBC may use at least one of the inter prediction methods described in the present disclosure.

The prediction signal generated by the predictor may be used to generate a reconstructed signal or to generate a residual signal. The subtractor 115 may generate a residual signal (residual block, residual sample array) by subtracting the prediction signal (predicted block, predicted sample array) output from the predictor from the input image signal (original block, original sample array). The generated residual signal may be transmitted to the transformer 120.

The transformer 120 may generate transform coefficients by applying a transform method to the residual signal. For example, the transform method may include at least one of Discrete Cosine Transform (DCT), Discrete Sine Transform (DST), Karhunen-Loeve Transform (KLT), Graph-Based Transform (GBT), or Conditionally Non-linear Transform (CNT). Here, GBT refers to a transform obtained from a graph when the relationship information between pixels is represented as a graph. CNT refers to a transform obtained based on a prediction signal generated by using all previously reconstructed pixels. The transform process may be applied to a pixel block of the same square size or to a non-square variable-sized block.

The quantizer 130 may quantize the transform coefficients and transmit them to the entropy encoder 190. The entropy encoder 190 may encode the quantized signal (information on the quantized transform coefficients) and output it as a bitstream. The information on the quantized transform coefficients may be referred to as residual information. The quantizer 130 may rearrange the block-shaped quantized transform coefficients into a one-dimensional vector based on a coefficient scan order and may generate the information on the quantized transform coefficients based on the one-dimensional vector of quantized transform coefficients.

The entropy encoder 190 may perform various encoding methods, such as exponential Golomb, context-adaptive variable length coding (CAVLC), or context-adaptive binary arithmetic coding (CABAC). The entropy encoder 190 may encode not only the quantized transform coefficients but also information necessary for video/image reconstruction (i.e., values of syntax elements) either together or separately with the quantized transform coefficients. The encoded information (i.e., encoded video/image information) may be transmitted or stored in the form of a bitstream in network abstraction layer (NAL) unit. The video/image information may further include information on various parameter sets, such as an adaptation parameter set (APS), a picture parameter set (PPS), a sequence parameter set (SPS), or a video parameter set (VPS). Additionally, the video/image information may further include general constraint information. The signaling information, transmitted information, and/or syntax elements described in the present disclosure may be included in the bitstream by being encoded through the above-described encoding process.

The bitstream may be transmitted through a network or stored in a digital storage medium. Here, the network may include a broadcast network and/or a communication network, etc., and the digital storage medium may include various storage media such as USB, SD, CD, DVD, Blu-ray, HDD, SSD, etc. A transmitter (not shown) for transmitting the signal output from the entropy encoder 190 and/or a storage unit (not shown) for storing the signal may be provided as an internal/external element of the image encoding apparatus 100, or the transmitter may be configured as a component of the entropy encoder 190.

The quantized transform coefficients output from the quantizer 130 may be used to generate a residual signal. For example, a residual signal (residual block or residual samples) may be reconstructed by applying dequantization and inverse transform to the quantized transform coefficients through the dequantizer 140 and the inverse transformer 150.

The adder 155 may generate a reconstructed signal (reconstructed picture, reconstructed block, or reconstructed sample array) by adding the reconstructed residual signal to the prediction signal output from the inter predictor 180 or the intra predictor 185. When there is no residual for the target block, such as when the skip mode is applied, the predicted block may be used as the reconstructed block. The adder 155 may be referred to as a reconstructor or a reconstructed block generator. The generated reconstructed signal may be used for intra prediction of the next target block within the current picture and, as described later, may also be used for inter prediction of the next picture after undergoing filtering.

Meanwhile, luma mapping with chroma scaling (LMCS) may be applied during picture encoding and/or reconstruction processes.

The filter 160 may apply filtering to the reconstructed signal to enhance subjective/objective quality. For example, the filter 160 may apply various filtering methods to the reconstructed picture to generate a modified reconstructed picture, and the modified reconstructed picture may be stored in the memory 170, specifically in the DPB of the memory 170. The various filtering methods may include, for example, deblocking filtering, sample adaptive offset, adaptive loop filter, bilateral filter, etc. The filter 160 may generate various filtering-related information, as described later in the explanations of each filtering method, and may transmit it to the entropy encoder 190. The filtering-related information may be encoded by the entropy encoder 190 and output in the form of a bitstream.

The modified reconstructed picture transmitted to the memory 170 may be used as a reference picture in the inter predictor 180. When inter prediction is applied in this case, the image encoding apparatus 100 may avoid prediction mismatches between the image encoding apparatus 100 and the image decoding apparatus, and may improve encoding efficiency.

The DPB in the memory 170 may store the modified reconstructed picture for use as a reference picture in the inter predictor 180. The memory 170 may store the motion information of a block in the current picture where motion information has been derived (or encoded) and/or the motion information of blocks in already reconstructed pictures. The stored motion information may be transmitted to the inter predictor 180 for use as motion information of spatial neighboring block or temporal neighboring block. The memory 170 may store the reconstructed samples of reconstructed blocks in the current picture and transmit them to the intra predictor 185.

### Overview of the Image Decoding Apparatus

FIG. 3 shows a schematic diagram of an image decoding apparatus to which an embodiment according to the present disclosure may be applied.

As shown in FIG. 3, the image decoding apparatus 200 may include an entropy decoder 210, a dequantizer 220, an inverse transformer 230, an adder 235, a filter 240, a memory 250, an inter predictor 260, and an intra predictor 265. The inter predictor 260 and the intra predictor 265 may collectively be referred to as a “predictor”. The dequantizer 220 and the inverse transformer 230 may be included in a residual processor.

All or at least some of the multiple components constituting the image decoding apparatus 200 may be implemented as a single hardware component (i.e., a decoder or a processor), depending on the embodiment. Additionally, the memory 170 may include a DPB and may be implemented by a digital storage medium.

The image decoding apparatus 200, which receives a bitstream containing video/image information, may perform a process corresponding to the process performed by the image encoding apparatus 100 in FIG. 2 to reconstruct the image. For example, the image decoding apparatus 200 may perform decoding using the processing unit applied in the image encoding apparatus. Therefore, the processing unit for decoding may be, for example, a coding unit. The coding unit may be a coding tree unit or may be obtained by splitting a largest coding unit. Additionally, the reconstructed image signal decoded and output through the image decoding apparatus 200 may be played back through a playback device (not shown).

The image decoding apparatus 200 may receive a signal output from the image encoding apparatus in FIG. 2 in the form of a bitstream. The received signal may be decoded through the entropy decoder 210. For example, the entropy decoder 210 may parse the bitstream to extract the information necessary for image reconstruction (or picture reconstruction) (i.e., video/image information). The video/image information may further include information on various parameter sets, such as an adaptation parameter set (APS), a picture parameter set (PPS), a sequence parameter set (SPS), or a video parameter set (VPS). Additionally, the video/image information may further include general constraint information. The image decoding apparatus may additionally use information on the parameter set and/or the general constraint information to decode the image. The signaling information, received information, and/or syntax elements described in the present disclosure may be obtained from the bitstream by being decoded through the decoding process. For example, the entropy decoder 210 may decode the information in the bitstream based on coding methods such as exponential Golomb encoding, CAVLC, or CABAC, and may output a syntax element value necessary for image reconstruction and quantized values of a transform coefficient related to a residual. More specifically, the CABAC entropy decoding method may receive a bin corresponding to a syntax element in the bitstream, may determine a context model using the information of the decoding target syntax element, the decoding information of neighboring block and the decoding target block, or information of previously decoded symbol/bin, may predict the probability of bin occurrence according to the determined context model, and may perform arithmetic decoding of the bin to generate a symbol corresponding to each syntax element. In this case, the CABAC entropy decoding method may update the context model for the next symbol/bin context model using the decoded symbol/bin information after determining the context model. Among the decoded information from the entropy decoder 210, the prediction-related information may be provided to the predictor (inter predictor 260 and intra predictor 265), and the residual value which is entropy decoded by the entropy decoder 210, in other words, the quantized transform coefficients and related parameter information, may be input to the dequantizer 220. Additionally, among the decoded information from the entropy decoder 210, filtering-related information may be provided to the filter 240. Meanwhile, a receiver (not shown) that receives the signal output from the image encoding apparatus may be additionally configured as an internal/external element of the image decoding apparatus 200, or the receiver may be configured as a component of the entropy decoder 210.

Meanwhile, the image decoding apparatus according to the present disclosure may also be referred to as a video/image/picture decoding apparatus. The image decoding apparatus may include an information decoder (video/image/picture information decoder) and/or a sample decoder (video/image/picture sample decoder). The information decoder may include the entropy decoder 210, and the sample decoder may include at least one of the dequantizer 220, the inverse transformer 230, the adder 235, the filter 240, the memory 250, the inter predictor 260, or the intra predictor 265.

TABLE 1

| Intra prediction | |
|---|---|
| mode | Associated name |
| 0 | INTRA_PLANAR |
| 1 | INTRA_DC |
| 2 . . . 66 | INTRA_ANGULAR2 . . . INTRA_ANGULAR66 |
| 81 . . . 83 | INTRA_LT_CCLM, INTRA_L_CCLM, |
| | INTRA_T_CCLM |

Meanwhile, the intra prediction type (or additional intra prediction mode, etc.) may include at least one of LIP, PDPC, MRL, ISP, or MIP described above. The intra prediction type may be indicated based on intra prediction type information, and the intra prediction type information may be implemented in various forms. As an example, the intra prediction type information may include an intra prediction type index that indicates one of the intra prediction types. In another example, the intra prediction type information may include at least one of reference sample line information (i.e., intra_luma_ref_idx) indicating whether MRL is applied to the current block and, when MRL is applied, which reference sample line is used, an ISP flag information (i.e., intra_subpartitions_mode_flag) indicating whether ISP is applied to the current block; ISP type information (i.e., intra_subpartitions_split_flag) indicating the partitioning type of subpartitions when ISP is applied, a flag information indicating whether PDPC is applied, or a flag information indicating whether LIP is applied. Additionally, the intra prediction type information may include an MIP flag (which may be referred to as intra_mip_flag) indicating whether MIP is applied to the current block.

### Overview of Template-Based Intra Mode Derivation (TIMD)

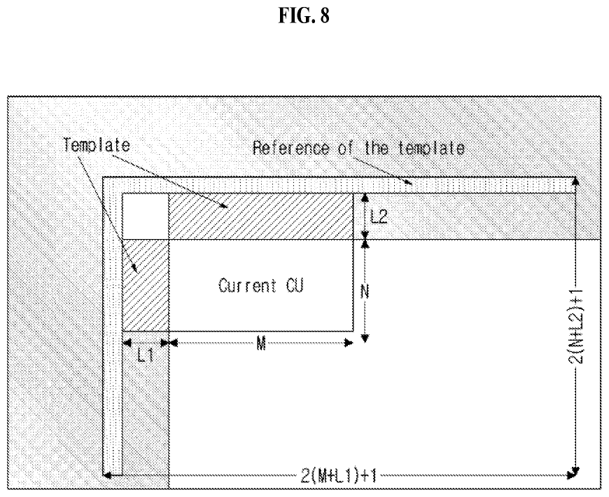

FIG. 8 is a diagram illustrating a template area used in a TIMD mode according to the present disclosure. For the intra prediction mode (IPM) intra mode of a neighboring adjacent intra block and inter block, as shown in FIG. 8, after calculating the sum of absolute transformed differences (SATD) between a prediction block predicted from a template area and an actual reconstructed sample, a mode with the smallest SATD may be selected as the intra mode of a current block.

In other words, the first two intra prediction modes with the minimum SATD are selected as a TIMD mode. These two TIMD modes are fused with a weight, and this weighted intra prediction is used to encode a current CU. Position dependent intra prediction combination (PDPC) may be included in the derivation process of a TIMD mode.

The cost of two selected modes is compared with a threshold value, and two cost factors are applied in a test as follows.

$$costMode 2 < 2 * costMode 1$$

If the condition is true, fusion is applied, and otherwise, only mode 1 is used.

The weight of a mode is calculated by their SATD cost as follows.

$$weight 1 = costMode 2 / ( costMode 1 + costMode 2 )$$

$$weight 2 = 1 - weight 1$$

### Template Matching (TM)

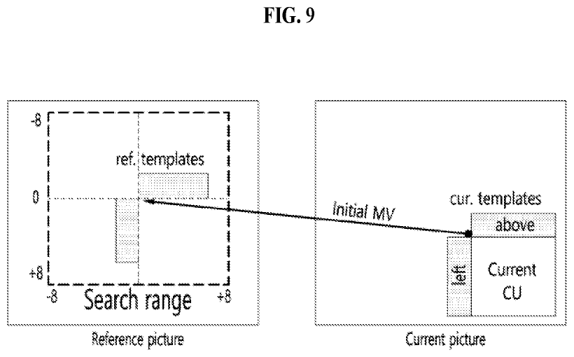

FIG. 9 is a diagram for describing a template matching-based encoding/decoding method according to the present disclosure.

Template Matching (TM) is a method for deriving a motion vector performed on a decoder side, which is a method for refining the motion information of a current block by finding a template (hereinafter, referred to as a “reference template”) within a reference picture that is most similar to a template (hereinafter, referred to as a “current template”) adjacent to a current block (e.g., a current coding unit, a current CU). A current template may be the top neighbor block and/or the left neighbor block of a current block or a part of their neighbor block. In addition, a reference template may be determined to have the same size as a current template.

As shown in FIG. 9, when the initial motion vector of a current block is derived, a search for a better motion vector may be performed in the neighboring area of an initial motion vector. For example, the range of a neighboring area where the search is performed may be within a [−8, +8]-pel search area, centering around an initial motion vector. In addition, the size of a search step for performing a search may be determined based on the AMVR mode of a current block. In addition, template matching may be performed continuously with a bilateral matching process in a merge mode.

When the prediction mode of a current block is an AMVP mode, a motion vector predictor candidate (MVP candidate) may be determined based on a template matching error. For example, a motion vector predictor candidate (MVP candidate) that minimizes an error between a current template and a reference template may be selected. Afterwards, template matching for refining a motion vector may be performed on the selected motion vector predictor candidate. In this case, template matching for refining a motion vector may not be performed on a motion vector predictor candidate that is not selected.

More specifically, refinement for the selected motion vector predictor candidate may start from full-pel (integer-pel) accuracy within a [−8, +8]-pel search area by using an iterative diamond search. Alternatively, for a 4-pel AMVR mode, it may start from 4-pel accuracy. Afterwards, a search for half-pel and/or quarter-pel accuracy may be followed according to an AMVR mode. According to the search process, a motion vector predictor candidate may maintain the same motion vector accuracy as indicated by an AMVR mode even after a template matching process. In the iterative search process, when a difference between a previous minimum cost and a current minimum cost is less than an arbitrary threshold value, the search process is terminated. The threshold value may be the same as the area of a block, i.e., the number of samples in a block. Table 2 is an example of a search pattern according to an AMVR mode and a merge mode with AMVR.

TABLE 2

| | AMVR mode | | | | | |
|---|---|---|---|---|---|---|
| | 4- | Full- | Half- | Quarter- | Merge mode | |
| Search pattern | pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel cross | | | | v | v | |
| ⅛-pel cross | | | | | v | |

When the prediction mode of a current block is a merge mode, a similar search method may be applied to a merge candidate indicated by a merge index. As shown in Table 2 above, template matching may be performed up to ⅛-pel accuracy or may skip half-pel accuracy or lower, which may be determined depending on whether an alternative interpolation filter is used according to merge motion information. In this case, the alternative interpolation filter may be a filter used when AMVR is a half-pel mode. In addition, when template matching is available, the template matching may operate as an independent process according to whether bilateral matching (BM) is available, or may operate as an additional motion vector refinement process between block-based bilateral matching and sub-block-based bilateral matching. Whether the template matching is available and/or whether bilateral matching is available may be determined according to checking availability conditions. In the above, the accuracy of a motion vector may mean the accuracy of a motion vector difference (MVD).

Overview of Intra Template Matching Prediction (intraTMP)

Intra Template Matching Prediction (IntraTMP) may be a special intra prediction mode that copies an optimal prediction block having an L-shaped template matching the template area of a current block from the reconstructed part of a current picture. For a predefined search range, an image encoding apparatus 100 may search for a template most similar to the template area of a current block within the reconstructed part of a current picture and use a corresponding block as a prediction block. Then, an image encoding apparatus 100 may signal information representing the use of an IntraTMP mode, and an image decoding apparatus 200 may perform the same prediction operation through signaled information.

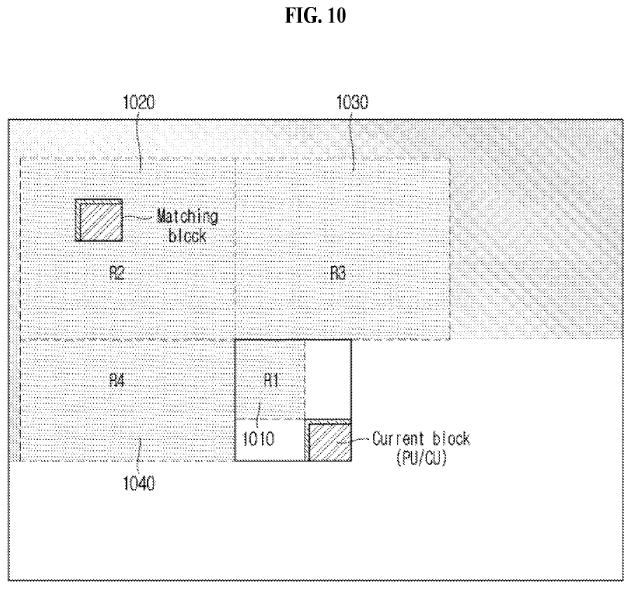

FIG. 10 is a diagram illustrating a search area used for intra template matching prediction (intraTMP) according to an embodiment of the present disclosure. A prediction block may be generated by matching the L-shaped causal neighbor of a current block with another block within four predefined search areas illustrated in FIG. 10. The four predefined search areas may be R1(1010), R2(1020), R3(1030) and R4(1040) defined below.
R1 (1010): Current CTU
R2 (1020): Top-left CTU
R3 (1030): Top CTU
R4 (1040): Left CTU

The sum of absolute differences (SAD) may be used as a cost function. Within each area, an image decoding apparatus 200 may search for a template having the minimum SAD regarding the template area of a current block and use the corresponding block of a searched template as a prediction block.

The dimensions (SearchRange_w, SearchRange_h) of all areas, as shown in Equation 1 below, may be set to be proportional to a block dimension (BlkW, BlkH) to have a fixed number of SAD comparisons per pixel.

[Equation 1]

SearchRange_w = a*BlkW
SearchRange_h = a*BlkH

In Equation 1, a may be a constant that controls gain/complexity trade-off. For example, a may be 5.

In order to perform a template matching process quickly, the search range of all search areas may be sub-sampled by a factor of 2. This leads to a reduction in template matching search by 4. After finding an optimal matching part, a refinement process may be performed. A refinement process may be performed through the second template matching search around an optimal matching area with a reduced range. Here, a reduced range may be defined by min (BlkW, BlkH)/2.

An intra template matching tool may be available for CUs that the sizes of the width and height are less than or equal to 64. The maximum CU size for intra template matching may be configured. In other words, the maximum CU size for intra template matching may be set arbitrarily. In addition, an intra template matching prediction mode may be signaled at a CU level through a dedicated flag when a decoder-side intra node derivation (DIMD) mode is not used for a current CU.

Hereinafter, an image encoding/decoding method according to an embodiment of the present disclosure will be described in detail.

The present disclosure may relate to intra prediction. Specifically, the present disclosure may relate to a method for generating a prediction block by flipping or rotating a reference block and/or the template area of a reference block in intra template matching prediction. Intra template matching prediction may be a method for deriving a block vector from an image decoding apparatus 200 and generating a prediction block corresponding to a derived block vector. Specifically, the present disclosure may propose a method for considering the rotation and flip of a template in the process of generating a template area to derive a block vector (BV) in an image decoding apparatus 200, in the process of predicting a BV based on a generated template area and in the process of generating a prediction block.

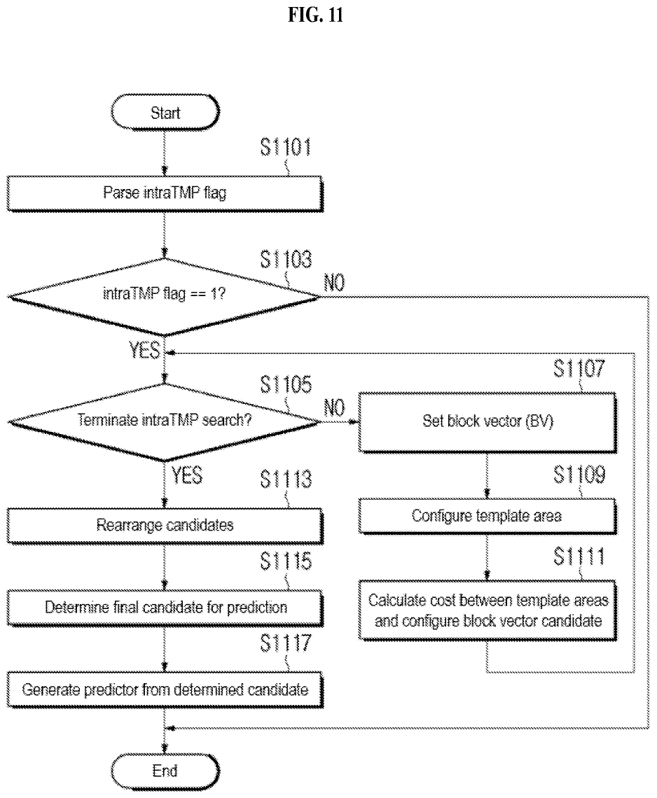

FIG. 11 is an intra template matching prediction flowchart according to an embodiment of the present disclosure. Referring to FIG. 11, an image decoding apparatus 200 may parse an intraTMP flag S1101. In other words, an image decoding apparatus 200 may decode intraTMP flag information transmitted to a bitstream. An image decoding apparatus 200 may check whether the value of an intraTMP flag is 1 S1103. When the value of an intraTMP flag is not 1 (NO in S1103), an image decoding apparatus 200 may terminate an intra template matching prediction-related procedure. When the value of an intraTMP flag is 1 (YES in S1103), an image decoding apparatus 200 may search for a template area. Specifically, an image decoding apparatus 200 may perform motion estimation or block vector estimation and calculate a motion extimation (ME) cost for each block vector until a predefined search process is terminated.

An image decoding apparatus 200 may check whether an intraTMP search is terminated S1105. In other words, whether a template area search for intra template matching prediction is terminated may be checked. When an intraTMP search is not terminated (NO in S1105), an image decoding apparatus 200 may set a block vector S1107. In other words, an image decoding apparatus 200 may perform initial setting for calculating a cost (an error) for a block vector during a predefined intraTMP search process. Thereafter, an image decoding apparatus 200 may configure a template area S1109. In other words, an image decoding apparatus 200 may configure a reference template by assuming that the template area of a reference block corresponding to the template area of a current block in a reference block corresponding to a block vector is a reference template. An image decoding apparatus 200 may calculate a cost between template areas and configure a block vector candidate S1111. Specifically, an image decoding apparatus 200 may calculate a similarity (a cost) between a reference template area configured in S1109 and the neighboring template area of a current block and insert a corresponding block vector into a candidate list. Thereafter, S1105 may be performed again.

When an intraTMP search is terminated (YES in S1105), an image decoding apparatus 200 may rearrange a candidate S1113. Specifically, when an intraTMP search is terminated, an image decoding apparatus 200 may calculate a similarity (a cost) for each candidate within a candidate list consisting of the number of cases of a block vector in S1111 and order calculated costs in ascending order.

An image decoding apparatus 200 may determine a final candidate for prediction S1115. In other words, an image decoding apparatus 200 may check a candidate index signaled from a bitstream to derive a candidate index within a rearranged candidate list in S1115. A candidate indicated by a candidate index signaled from a bitstream may be determined as a final candidate. Alternatively, when there is no candidate index signaled from a bitstream, the most similar candidate among the candidates within a reordered candidate list may be used as a final prediction candidate.

An image decoding apparatus 200 may generate a predictor from a determined candidate S1117. In other words, an image decoding apparatus 200 may fetch a prediction block by using the block vector of a final prediction candidate determined in S1115.

### Embodiment 1

In order to derive a block vector through intra template matching prediction, the present disclosure proposes a method for deriving a block vector by applying rotation transformation and/or flip transformation to the template area of a reference block and calculating a similarity (i.e., a cost, an error value) between the template area of a transformed reference block (i.e., the first adjacent area) and the template area of a current block (i.e., the second adjacent area).

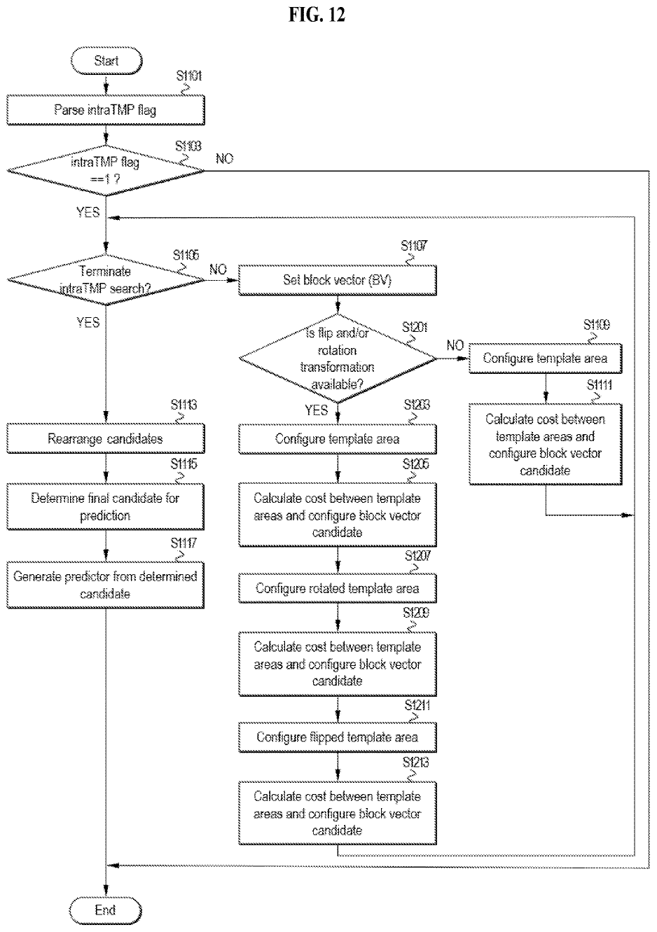

FIG. 12 is an intra template matching prediction flowchart according to an embodiment of the present disclosure. S1101 to S1117 in FIG. 12 may be the same as each step in FIG. 11. According to an embodiment of the present disclosure, when an intraTMP search is not terminated (NO in S1107), an image decoding apparatus 200 may set a block vector S1107. Thereafter, an image decoding apparatus 200 may check whether flip and/or rotation transformation is available S1201. An image decoding apparatus 200 may check whether a profile or an application supports the rotation and/or flip transformation of intraTMP through a high level syntax. In addition, an image decoding apparatus 200 may check whether a corresponding module supports rotation and/or flip transformation based on information obtained through a high level syntax.

An image decoding apparatus 200 may configure a template area S1203. In other words, an image decoding apparatus 200 may assume that the template area (i.e., the first adjacent area) of a reference block corresponding to the template area (i.e., the second adjacent area) of a current block in a reference block corresponding to a block vector is a reference template.

An image decoding apparatus 200 may calculate a cost between template areas and configure a block vector candidate S1205. In other words, it may calculate a similarity (a cost) between a reference template area configured in S1203 and the template area of a current block and insert a corresponding block vector into a candidate list.

An image decoding apparatus 200 may configure a rotated template area S1207. Specifically, an image decoding apparatus 200 may assume the template area of a reference block corresponding to the template area of a current block in a reference block corresponding to a block vector as a reference template, and then perform rotation transformation on a corresponding reference template to configure a rotated reference template. Here, rotation transformation may include at least one of 90-degree counterclockwise rotation transformation, 180-degree counterclockwise rotation transformation or 270-degree counterclockwise rotation transformation. However, the present disclosure is not limited thereto and may perform rotation transformation at various angles.

An image decoding apparatus 200 may calculate a cost between template areas and configure a block vector candidate S1209. In other words, it may calculate a similarity (a cost) between a rotation-transformed reference template area configured in S1207 and the template area of a current block and insert a corresponding block vector into a candidate list.

An image decoding apparatus 200 may configure a flipped template area S1211. Specifically, an image decoding apparatus 200 may assume the template area of a reference block corresponding to the template area of a current block in a reference block corresponding to a block vector as a reference template, and then perform flip transformation on a corresponding reference template to configure a flipped reference template. Here, flip transformation may include at least one of vertical flip transformation, horizontal flip transformation, diagonal flip transformation or vertical diagonal flip transformation. However, the present disclosure is not limited thereto and may perform flip transformation based on flip axes in various directions.

An image decoding apparatus 200 may calculate a cost between template areas and configure a block vector candidate S1213. In other words, it may calculate a similarity (a cost) between a flip-transformed reference template area configured in S1211 and the template area of a current block and insert a corresponding block vector into a candidate list. The present disclosure is not limited thereto, and the order of S1207 and S1211 described above may be changed. In addition, S1207 and S1209 may be omitted. Alternatively, S1211 and S1213 may be omitted.

According to an embodiment of the present disclosure, a block vector may be derived by rotating and/or flipping the template area of a reference block in order to derive a block vector through intra template matching prediction. In this case, rotation and/or flip may be performed on a reference block corresponding to a current block, and a rotation and/or flip-transformed reference block may be used as the prediction block of a current block.

IntraTMP may perform motion estimation based on an image decoding apparatus 200 for finding a similar block vector by calculating the similarity (i.e., cost, error value) of template areas. Accordingly, the present disclosure proposes a method for performing rotation and/or flip transformation on the template area of a reference block corresponding to a block vector (hereinafter, a reference template area) and proposes a process for calculating a similarity between a reference template area to which rotation and/or flip is applied and the template area of a current block and finding a block vector with a high similarity in the entire reference template area. In other words, a proposed method may be a method for performing motion estimation (ME) by performing the rotation and/or flip transformation of a reference template area to derive a block vector in an image decoding apparatus 200.

The shape of a block supported by a hybrid-based image decoding apparatus 200 may vary. For example, the shape of a block to be generated may be square or rectangular. Alternatively, the shape of a block may be a variety of atypical shapes such as a triangle, etc., not a quadrangle, according to the prediction technology. Accordingly, the present disclosure proposes a method for performing rotation and/or flip transformation-based intraTMP for blocks of various shapes.

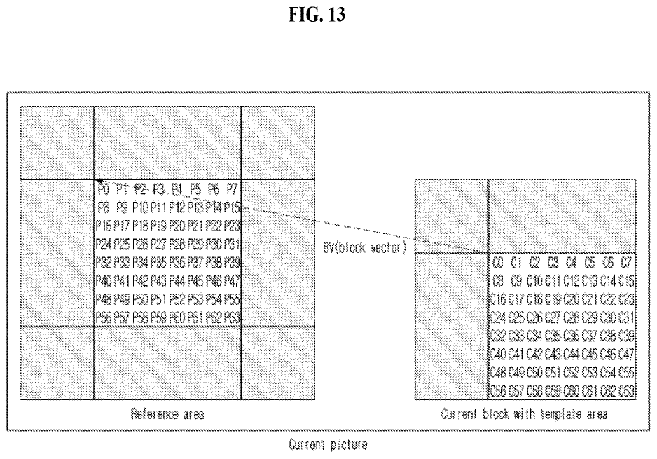

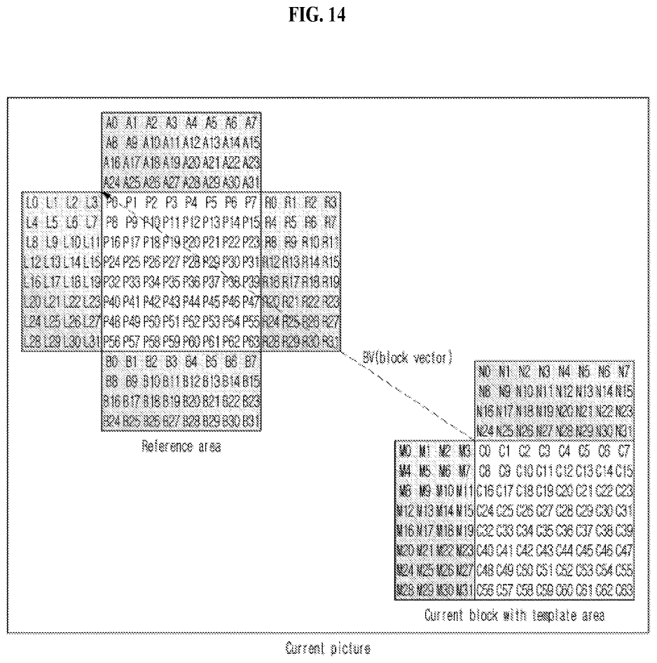

FIGS. 13 and 14 are diagrams illustrating template areas of a current block and a reference block according to an embodiment of the present disclosure. The shaded parts of FIGS. 13 and 14 may be a template area, and an unshaded part represents a current block and a reference block corresponding to a block vector.

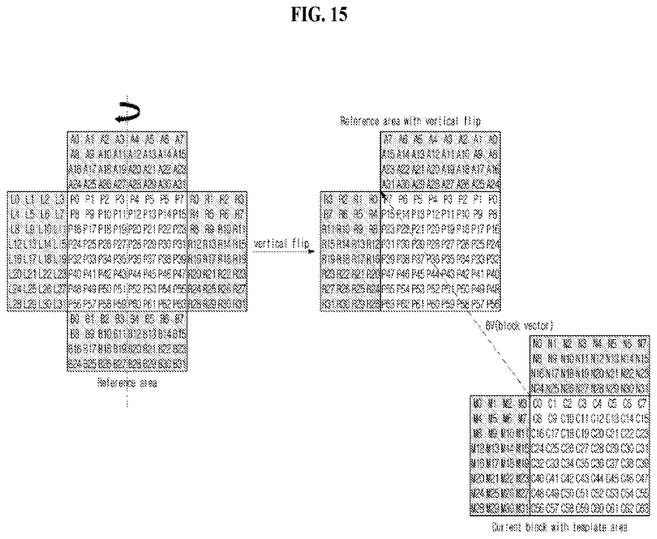

FIG. 15 is a diagram in which vertical flip transformation is applied to a reference block and the template area of a reference block according to an embodiment of the present disclosure. Referring to FIG. 15, the present disclosure may derive a block vector by applying vertical flip transformation to a reference block and the template area of a reference block. An image encoding apparatus 100 and/or an image decoding apparatus 200 may calculate a similarity between the template area of a current block and the template area of a reference block to which vertical flip transformation is applied by applying vertical flip transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply vertical flip transformation to a candidate prediction block generated based on a block vector, and may generate the final prediction block of a current block by fetching a candidate prediction block to which vertical flip transformation is applied.

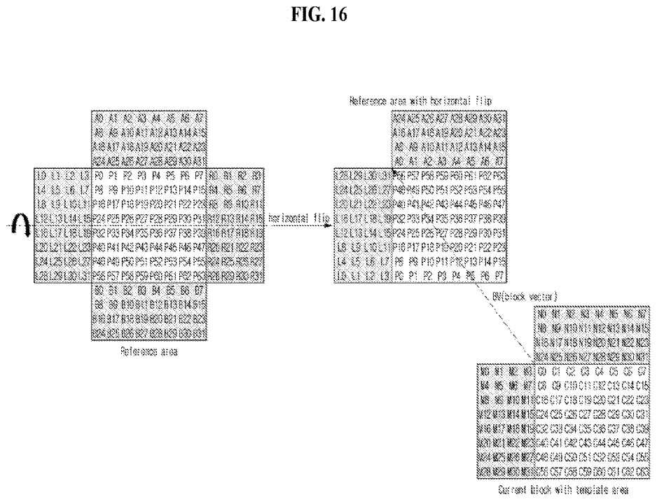

FIG. 16 is a diagram in which horizontal flip transformation is applied to a reference block and the template area of a reference block according to an embodiment of the present disclosure. Referring to FIG. 16, the present disclosure may derive a block vector by applying horizontal flip transformation to a reference block and the template area of a reference block. An image encoding apparatus 100 and/or an image decoding apparatus 200 may calculate a similarity between the template area of a current block and the template area of a reference block to which horizontal flip transformation is applied by applying horizontal flip transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply horizontal flip transformation to a candidate prediction block generated based on a block vector, and may generate the final prediction block of a current block by fetching a candidate prediction block to which horizontal flip transformation is applied.

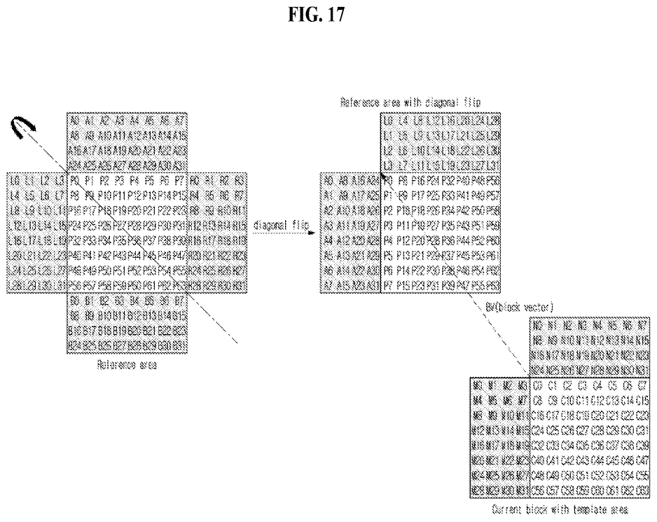

FIG. 17 is a diagram in which diagonal flip transformation is applied to a reference block and the template area of a reference block according to an embodiment of the present disclosure. Referring to FIG. 17, the present disclosure may derive a block vector by applying diagonal flip transformation to a reference block and the template area of a reference block. An image encoding apparatus 100 and/or an image decoding apparatus 200 may calculate a similarity between the template area of a current block and the template area of a reference block to which diagonal flip transformation is applied by applying diagonal flip transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply diagonal flip transformation to a candidate prediction block generated based on a block vector, and may generate the final prediction block of a current block by fetching a candidate prediction block to which diagonal flip transformation is applied.

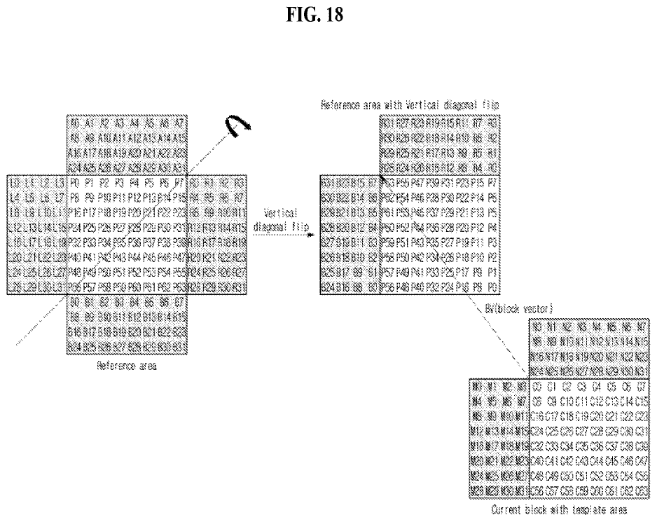

FIG. 18 is a diagram in which vertical diagonal flip transformation is applied to a reference block and the template area of a reference block according to an embodiment of the present disclosure. Referring to FIG. 17, the present disclosure may derive a block vector by applying vertical diagonal flip transformation to a reference block and the template area of a reference block. An image encoding apparatus 100 and/or an image decoding apparatus 200 may calculate a similarity between the template area of a current block and the template area of a reference block to which vertical diagonal flip transformation is applied by applying vertical diagonal flip transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply vertical diagonal flip transformation to a candidate prediction block generated based on a block vector, and may generate the final prediction block of a current block by fetching a candidate prediction block to which vertical diagonal flip transformation is applied.

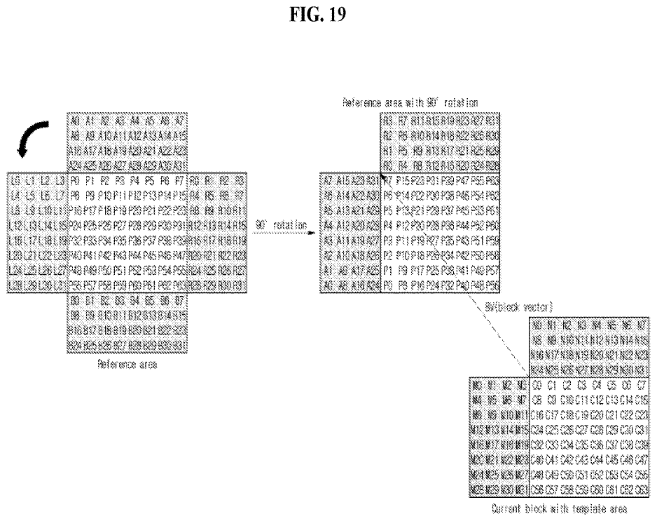

FIG. 19 is a diagram in which 90-degree counterclockwise rotation transformation is applied to a reference block and the template area of a reference block according to an embodiment of the present disclosure. Referring to FIG. 19, the present disclosure may derive a block vector by applying 90-degree counterclockwise rotation transformation to a reference block and the template area of a reference block. An image encoding apparatus 100 and/or an image decoding apparatus 200 may calculate a similarity between the template area of a current block and the template area of a reference block to which 90-degree counterclockwise rotation transformation is applied by applying 90-degree counterclockwise rotation transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply 90-degree counterclockwise rotation transformation to a candidate prediction block generated based on a block vector, and may generate the final prediction block of a current block by fetching a candidate prediction block to which 90-degree counterclockwise rotation transformation is applied.

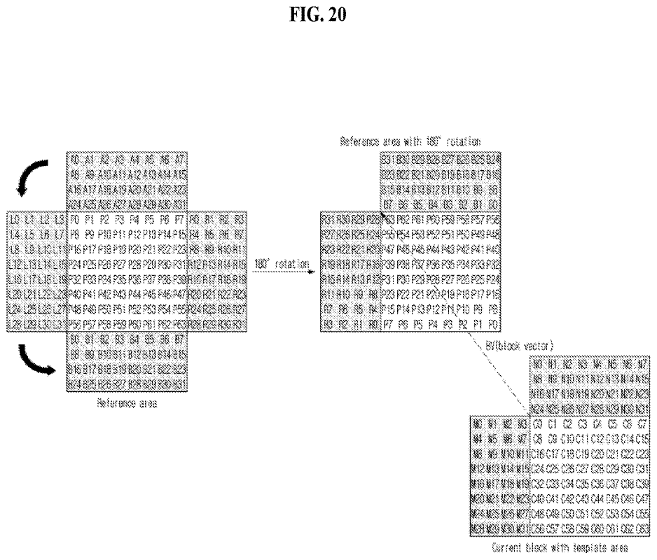

FIG. 20 is a diagram in which 180-degree counterclockwise rotation transformation is applied to a reference block and the template area of a reference block according to an embodiment of the present disclosure. Referring to FIG. 20, the present disclosure may derive a block vector by applying 180-degree counterclockwise rotation transformation to a reference block and the template area of a reference block. An image encoding apparatus 100 and/or an image decoding apparatus 200 may calculate a similarity between the template area of a current block and the template area of a reference block to which 180-degree counterclockwise rotation transformation is applied by applying 180-degree counterclockwise rotation transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply 180-degree counterclockwise rotation transformation to a candidate prediction block generated based on a block vector, and may generate the final prediction block of a current block by fetching a candidate prediction block to which 180-degree counterclockwise rotation transformation is applied.

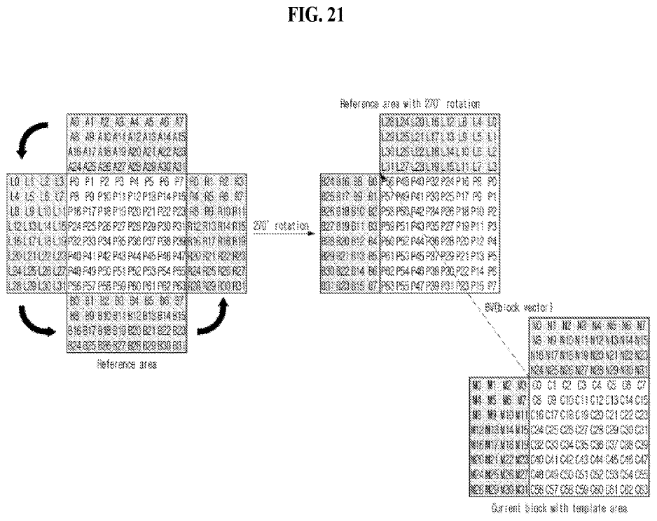

FIG. 21 is a diagram in which 270-degree counterclockwise rotation transformation is applied to a reference block and the template area of a reference block according to an embodiment of the present disclosure. Referring to FIG. 21, the present disclosure may derive a block vector by applying 270-degree counterclockwise rotation transformation to a reference block and the template area of a reference block. An image encoding apparatus 100 and/or an image decoding apparatus 200 may calculate a similarity between the template area of a current block and the template area of a reference block to which 270-degree counterclockwise rotation transformation is applied by applying 270-degree counterclockwise rotation transformation to the template area of a reference block. The prediction block of a current block may be generated by using a block vector derived through similarity calculation. In this case, in order to generate the prediction block of a current block, an image encoding apparatus 100 and/or an image decoding apparatus 200 may apply 270-degree counterclockwise rotation transformation to a candidate prediction block generated based on a block vector, and may generate the final prediction block of a current block by fetching a candidate prediction block to which 270-degree counterclockwise rotation transformation is applied.

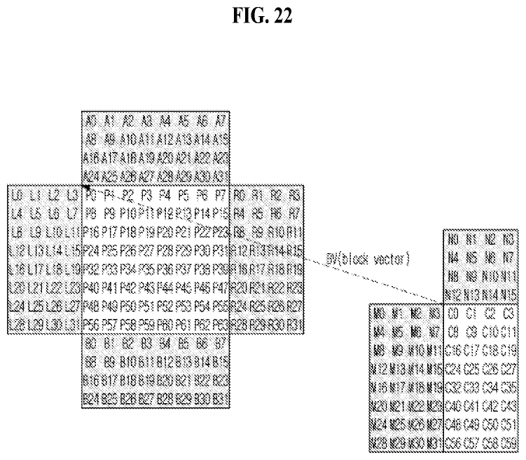

FIG. 22 is a diagram illustrating a reference block and a template area when a current block is a rectangle according to an embodiment of the present disclosure. Specifically, FIG. 22 is a diagram illustrating a reference block and the template area of a reference block to which rotation and/or flip transformation is not applied. Unlike a square block, a referenced area may be adaptively determined for a non-square block according to rotation and/or flip.

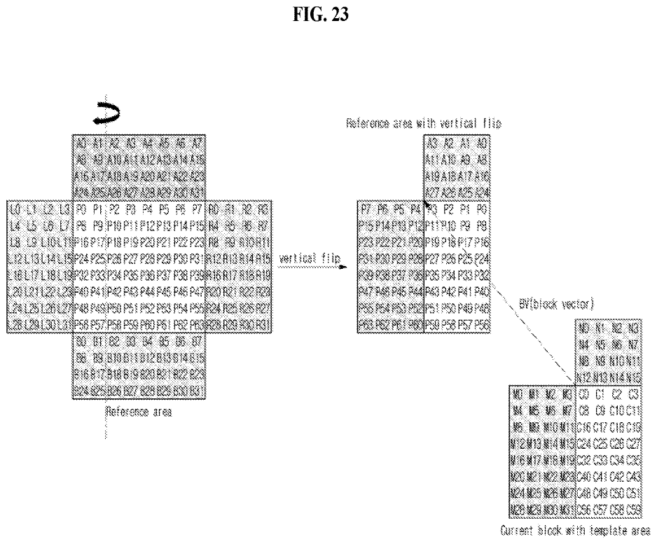

FIG. 23 is a diagram in which vertical flip transformation is applied to a reference block and the template area of a reference block when a current block is a rectangular block according to an embodiment of the present disclosure. When the height of a current block is twice the width (i.e., an N×2N block, where N is an integer), vertical flip transformation may also be applied to a reference block and the template area of a reference block by considering the ratio of the height and width of a current block. For example, when the size of a current block is N×2N, vertical flip transformation may also be performed on a reference block based on an N×2N part at the same position of a current block. For the template area of a reference block, vertical flip transformation may also be performed on a template area with the same width and/or height by considering the width and/or height of a current block.

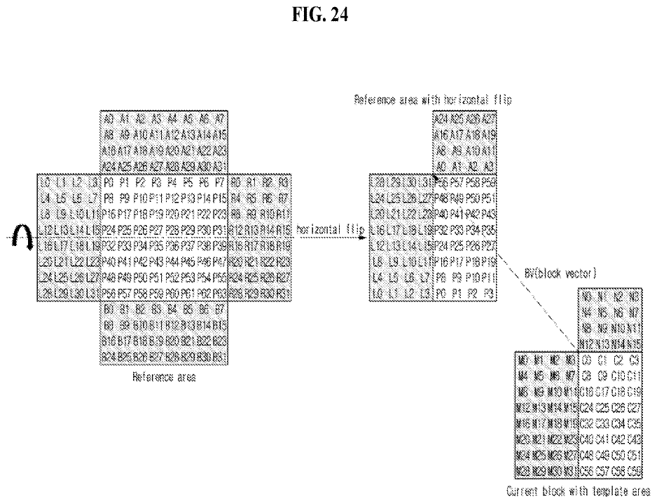

FIG. 24 is a diagram in which horizontal flip transformation is applied to a reference block and the template area of a reference block when a current block is a rectangular block according to an embodiment of the present disclosure. For a rectangular block, when performing horizontal flip transformation, a problem may occur that an area where a sample is not defined is generated due to a difference between the width and height of a current block. In order to solve this problem, the present disclosure may perform horizontal flip transformation after assuming that it is a square block based on the longer area between the width and height of a current block. This process may be applied equally to all rotation transformations and flip transformations. When the height of a current block is twice the width (i.e., an N×2N block, where Nis an integer), horizontal flip transformation may be performed on a reference block and the template area of a reference block in the same manner as a case for a 2N×2N-sized square block. In this case, only an area of the same size as a current block among a reference block and the template area of a reference block where horizontal flip transformation is performed may be considered when the prediction block of a current block is generated.

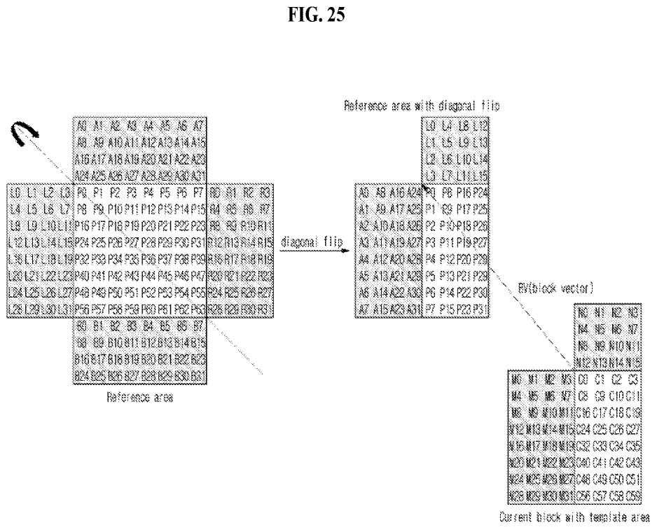

FIG. 25 is a diagram in which diagonal flip transformation is applied to a reference block and the template area of a reference block when a current block is a rectangular block according to an embodiment of the present disclosure. For a rectangular block, when performing diagonal flip transformation, a problem may occur that an area where a sample is not defined is generated due to a difference between the width and height of a current block. In order to solve this problem, the present disclosure may perform diagonal flip transformation after assuming that it is a square block based on the longer area between the width and height of a current block. When the height of a current block is twice the width (i.e., an N×2N block, where Nis an integer), diagonal flip transformation may be performed on a reference block and the template area of a reference block in the same manner as a case for a 2N×2N-sized square block. In this case, only an area of the same size as a current block among a reference block and the template area of a reference block where diagonal flip transformation is performed may be considered when the prediction block of a current block is generated.

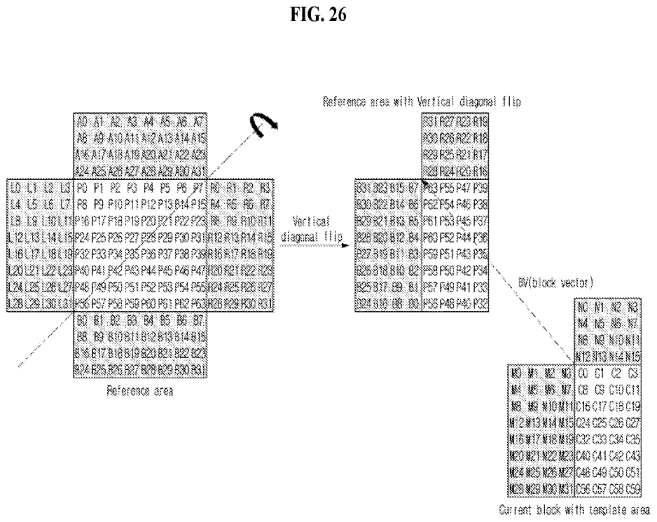

FIG. 26 is a diagram in which vertical diagonal flip transformation is applied to a reference block and the template area of a reference block when a current block is a rectangular block according to an embodiment of the present disclosure. For a rectangular block, when performing vertical diagonal flip transformation, a problem may occur that an area where a sample is not defined is generated due to a difference between the width and height of a current block. In order to solve this problem, the present disclosure may perform vertical diagonal flip transformation after assuming that it is a square block based on the longer area between the width and height of a current block. When the height of a current block is twice the width (i.e., an N×2N block, where N is an integer), vertical diagonal flip transformation may be performed on a reference block and the template area of a reference block in the same manner as a case for a 2N×2N-sized square block. In this case, only an area of the same size as a current block among a reference block and the template area of a reference block where vertical diagonal flip transformation is performed may be considered when the prediction block of a current block is generated.

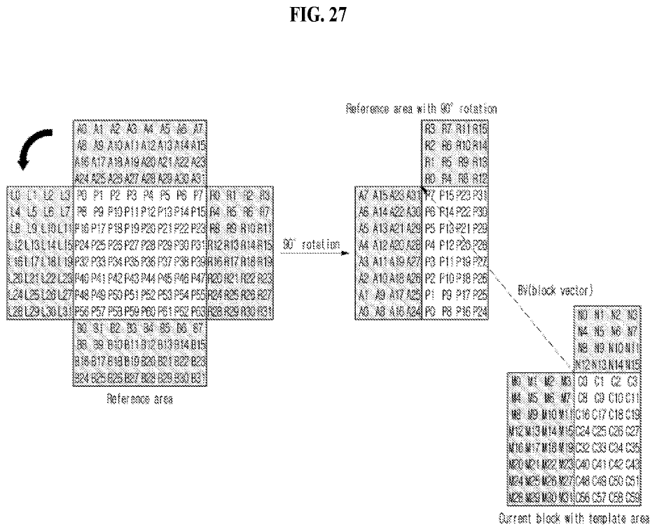

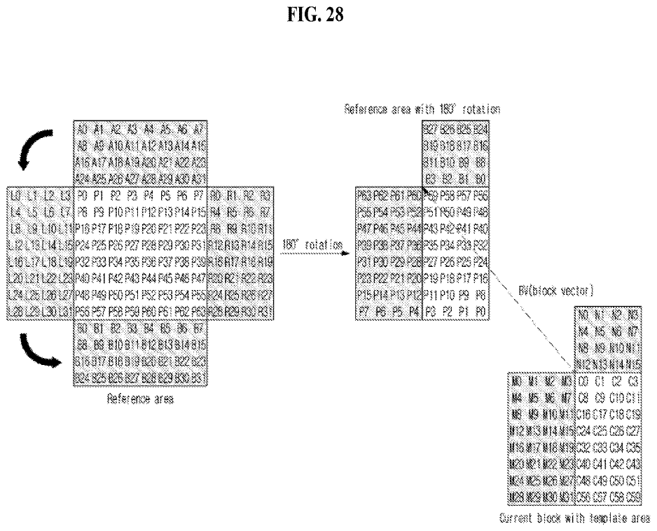

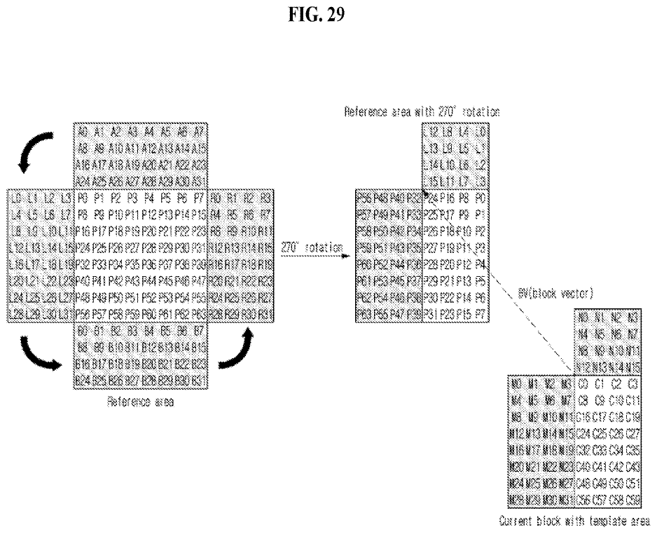

FIG. 27 is a diagram in which 90-degree counterclockwise rotation transformation is applied to a reference block and the template area of a reference block when a current block is a rectangular block according to an embodiment of the present disclosure. FIG. 28 is a diagram in which 180-degree counterclockwise rotation transformation is applied to a reference block and the template area of a reference block when a current block is a rectangular block according to an embodiment of the present disclosure. FIG. 29 is a diagram in which 270-degree counterclockwise rotation transformation is applied to a reference block and the template area of a reference block when a current block is a rectangular block according to an embodiment of the present disclosure.

For a rectangular block, when performing rotation transformation (e.g., 90-degree counterclockwise rotation transformation, 180-degree counterclockwise rotation transformation, 270-degree counterclockwise rotation transformation), a problem may occur that an area where a sample is not defined is generated due to a difference between the width and height of a current block. In order to solve this problem, the present disclosure may perform rotation transformation after assuming that it is a square block based on the longer area between the width and height of a current block. For example, when the height of a current block is twice the width (i.e., an N×2N block, where Nis an integer), rotation transformation may be performed on a reference block and the template area of a reference block in the same manner as a case for a 2N×2N-sized square block. In this case, only an area of the same size as a current block among a reference block and the template area of a reference block where rotation transformation is performed may be considered when the prediction block of a current block is generated.

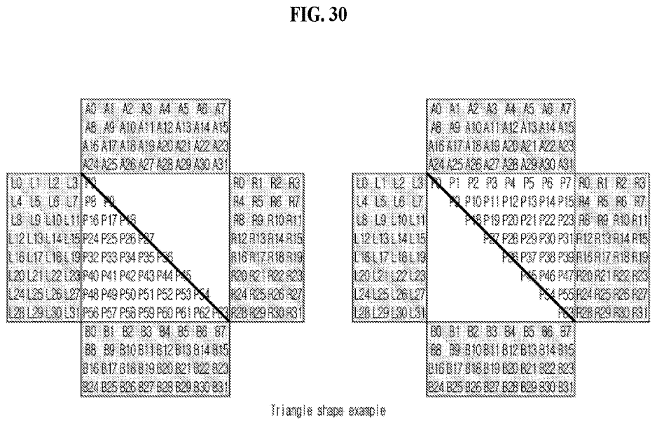

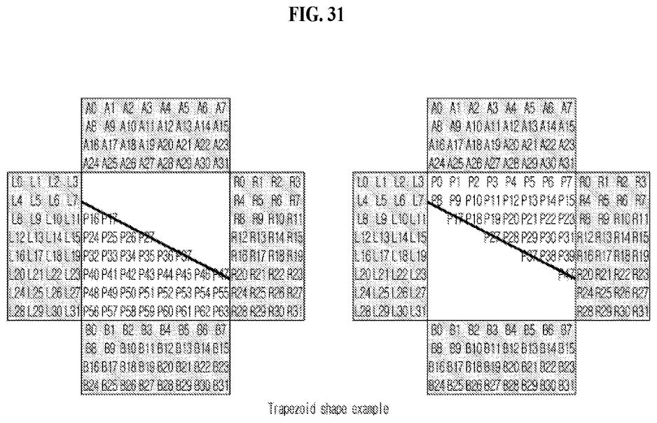

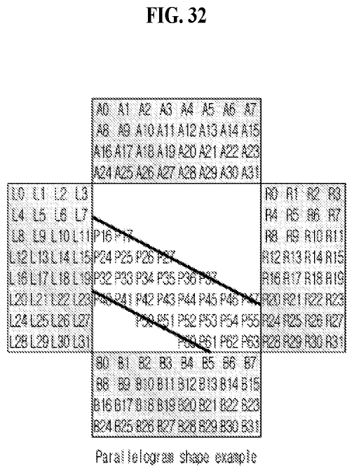

For 180-degree counterclockwise rotation transformation, there is no difference in the horizontal and vertical ratio of a block after rotation, but the left template area of a reference block after rotation may be substituted with reference block samples before rotation. In other words, a template area after rotation may be reference block samples before rotation. FIGS. 30 to 32 are diagrams illustrating a reference block and the template area of a reference block when a current block is a non-square block according to an embodiment of the present disclosure. In other words, the present disclosure may also be applied to blocks of various shapes.

According to an embodiment of the present disclosure, rotation and/or flip transformation may be performed only on a reference block, and rotation and/or flip transformation may not be performed on the template area of a reference block. Alternatively, rotation and/or flip transformation may be performed only on the template area of a reference block, and rotation and/or flip transformation may not be performed on a reference block.

### Embodiment 2

The present disclosure proposes a method for generating a prediction block by performing rotation and/or flip transformation on the pixel value of a reference area within a reference block corresponding to a current block during an intra template matching prediction process. The present disclosure proposes a method for signaling whether rotation and/or flip transformation is performed on the pixel value of a reference area within a reference block from a bitstream. All methods proposed in Embodiment 2 may be applied to all rotation and/or flip transformations proposed in Embodiment 1 described above.

Since a method proposed in the present disclosure transmits whether the rotation and/or flip transformation of a reference block is performed from a bitstream, an image encoding apparatus 100 may perform rate distortion optimization for a case where rotation and/or flip transformation is performed. Accordingly, an image encoding apparatus 100 may determine a case with the minimum reconstruction error value and transmit it to a bitstream. It is to enable an image decoding apparatus 200 to perform the same prediction process as an image encoding apparatus 100.

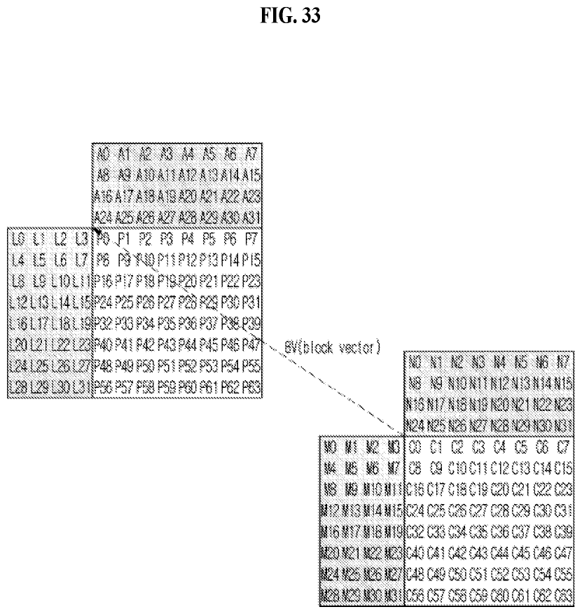

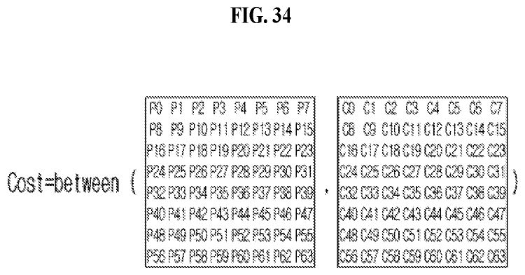

FIG. 33 is a diagram illustrating template areas of a current block and a reference block according to an embodiment of the present disclosure. FIG. 34 is a diagram illustrating a prediction error calculation method between a reference block and a current block according to an embodiment of the present disclosure. FIG. 34 is a diagram describing a method for calculating a prediction error by using a reference block and a current block in FIG. 33.

Specifically, the present disclosure may calculate a prediction error between a current block and a corresponding reference block indicated by a block vector.

According to an embodiment of the present disclosure, rotation and/or flip transformation may be performed on a corresponding reference block indicated by a block vector, and a prediction error between a current block and a reference block where transformation is performed.

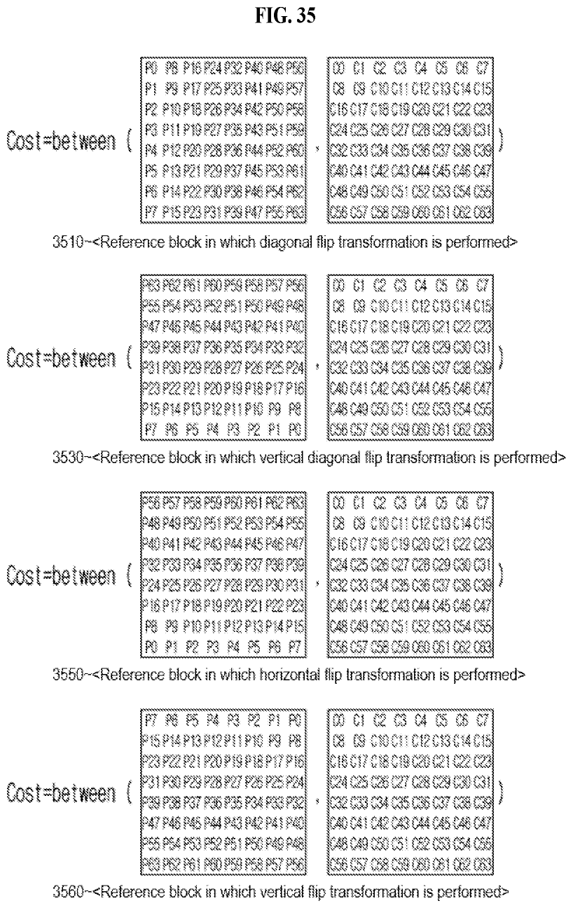

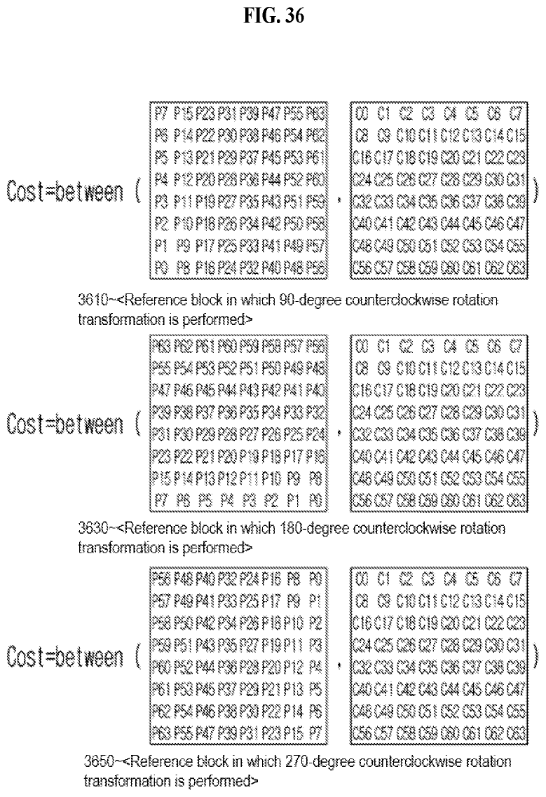

FIG. 35 is a diagram illustrating a prediction error calculation method between a flip-transformed reference block and a current block according to an embodiment of the present disclosure. FIG. 36 is a diagram illustrating a prediction error calculation method between a rotation-transformed reference block and a current block according to an embodiment of the present disclosure. As illustrated in FIGS. 35 and 36, an image encoding apparatus 100 may calculate an actual prediction error for rotation and/or flip transformation. Information on a case where the minimum prediction error of them is generated may be transmitted to a bitstream. An image decoding apparatus 200 may generate a final prediction block by determining whether a prediction block is rotated and/or flipped based on information received from a bitstream.

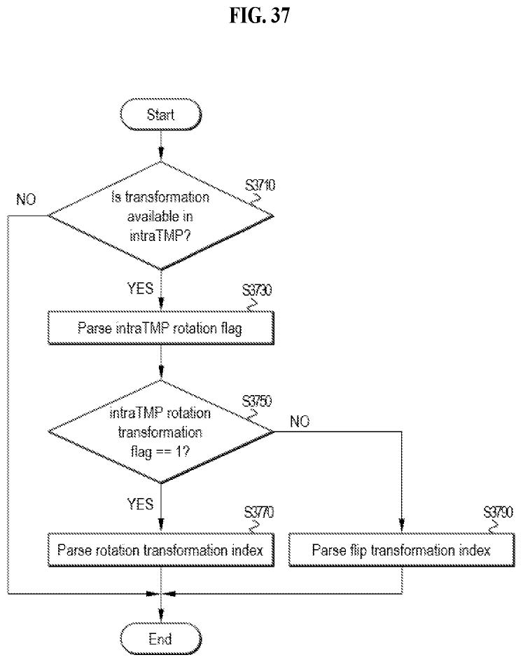

FIGS. 37 to 39 are flowcharts of a method for determining whether to perform transformation according to an embodiment of the present disclosure. Referring to FIG. 37, an image decoding apparatus 200 may check whether transformation is available in intraTMP S3710. In intraTMP, determining whether transformation is available may be performed based on information obtained from a bitstream, and availability may also be derived from an image decoding apparatus 200 without separate information from a bitstream.

When transformation is not available in intraTMP (NO in S3710), an image decoding apparatus 200 may terminate a corresponding step. When transformation is available in intraTMP (YES in S3710), an image decoding apparatus 200 may parse an intraTMP rotation flag S3730. Thereafter, an image decoding apparatus 200 may check the value of an intraTMP rotation transformation flag S3750. When the value of an intraTMP rotation transformation flag is 1 (YES in S3750), an image decoding apparatus 200 may parse a rotation transformation index S3770. When the value of an intraTMP rotation transformation flag is not 1 (NO in S3750), an image decoding apparatus 200 may parse a flip transformation index S3790. An image decoding apparatus 200 may perform transformation on a reference block and/or the template area of a reference block based on an index obtained in S3770 or S3790.

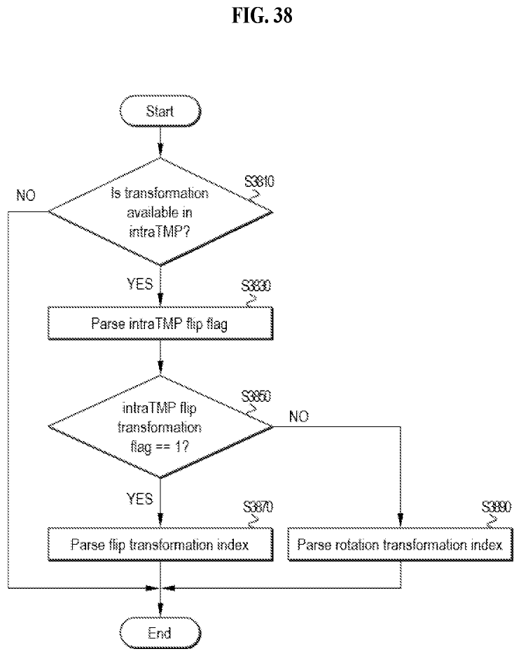

Referring to FIG. 38, an image decoding apparatus 200 may check whether transformation is available in intraTMP S3810. In intraTMP, determining whether transformation is available may be performed based on information obtained from a bitstream, and availability may also be derived from an image decoding apparatus 200 without separate information from a bitstream.

When transformation is not available in intraTMP (NO in S3810), an image decoding apparatus 200 may terminate a corresponding step. When transformation is available in intraTMP (YES in S3810), an image decoding apparatus 200 may parse an intraTMP flip flag S3830. Thereafter, an image decoding apparatus 200 may check the value of an intraTMP flip transformation flag S3850. When the value of an intraTMP flip transformation flag is 1 (YES in S3850), an image decoding apparatus 200 may parse a flip transformation index S3870. When the value of an intraTMP flip transformation flag is not 1 (NO in S3850), an image decoding apparatus 200 may parse a rotation transformation index S3890. An image decoding apparatus 200 may perform transformation on a reference block and/or the template area of a reference block based on an index obtained in S3870 or S3890.

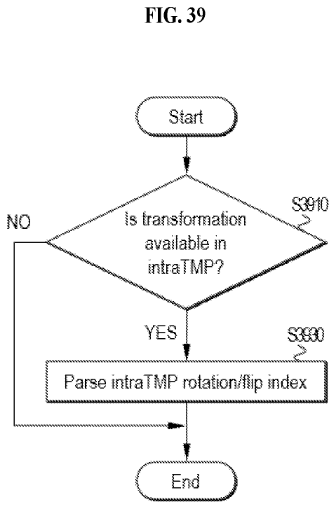

Referring to FIG. 39, an image decoding apparatus 200 may check whether transformation is available in intraTMP S3910. In intraTMP, determining whether transformation is available may be performed based on information obtained from a bitstream, and availability may also be derived from an image decoding apparatus 200 without separate information from a bitstream.

When transformation is not available in intraTMP (NO in S3910), an image decoding apparatus 200 may terminate a corresponding step. When transformation is available in intraTMP (YES in S3910), an image decoding apparatus 200 may parse an intraTMP rotation/flip index S3930. An image decoding apparatus 200 may perform transformation on a reference block and/or the template area of a reference block based on an index obtained in S3930.

When a rotation transformation index and the a flip transformation index are transmitted as a separate index as shown in FIGS. 37 and 38, the meaning of each index value may be the same as shown in Tables 3 and 4 below. Table 3 represents a rotation transformation index, and Table 4 represents a flip transformation index.

TABLE 3

| Rotation index | Semantic |
|---|---|
| 0 | 90-degree rotation |
| 1 | 180-degree rotation |
| 2 | 270-degree rotation |

TABLE 4

| Flip index | Semantic |
|---|---|
| 0 | Horizontal flip |
| 1 | Vertical flip |
| 2 | Diagonal flip |
| 3 | Vertical diagonal flip |

When a rotation transformation type and a flip transformation type are transmitted as one index as shown in FIG. 39, the meaning of an index value may be the same as shown in Table 5 below.

TABLE 5

| Rotation/flip index | Semantic |
|---|---|
| 0 | Horizontal flip |
| 1 | Vertical flip |
| 2 | Diagonal flip |
| 3 | Vertical diagonal flip |
| 4 | 90-degree rotation |
| 5 | 180-degree rotation |
| 6 | 270-degree rotation |

When whether rotation and/or flip transformation is transmitted as a bitstream, the present disclosure proposes a method for ordering indexes in ascending order based on a template similarity (cost) between a current block and a reference block to minimize the amount of transmitted bits. For example, when having a template similarity as shown in Table 6 below, an image encoding apparatus 100 and/or an image decoding apparatus 200 may reorder index values in ascending order of template similarity (cost) as shown in Table 7.

TABLE 6

| Rotation/flip index | Semantic | Cost |
|---|---|---|
| 0 | Horizontal flip | 100 |
| 1 | Vertical flip | 200 |
| 2 | Diagonal flip | 30 |
| 3 | Vertical diagonal flip | 10 |
| 4 | 90-degree rotation | 40 |
| 5 | 180-degree rotation | 300 |
| 6 | 270-degree rotation | 400 |

TABLE 7

| Rotation/flip index | Semantic | Cost |
|---|---|---|
| 0 | Vertical diagonal flip | 10 |
| 1 | Diagonal flip | 30 |
| 2 | 90-degree rotation | 40 |
| 3 | Horizontal flip | 100 |
| 4 | Vertical flip | 200 |
| 5 | 180-degree rotation | 300 |
| 6 | 270-degree rotation | 400 |

The present disclosure is not limited thereto, and reordering may also be performed in descending order of template similarity (cost).

### Embodiment 3

The present disclosure proposes a method for applying illumination compensation to a prediction block. In addition, the present disclosure proposes a method for deriving the compensation information (e.g., parameter) of illumination compensation by referring to the template area of a current block and the template area of a reference block rotated and/or flipped when rotation and/or flip transformation is applied in an intraTMP prediction process.

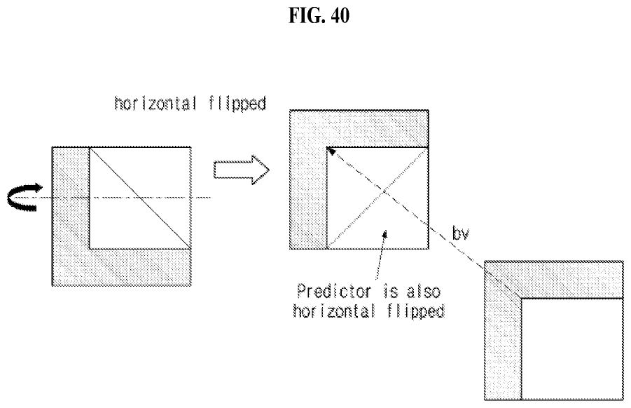

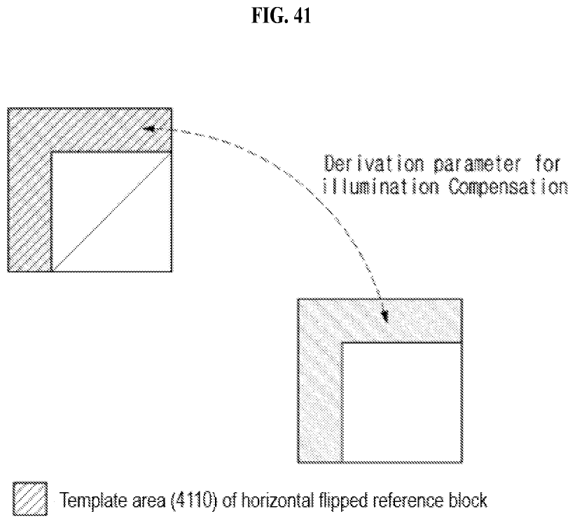

FIGS. 40 and 41 are diagrams illustrating an illumination compensation performance method according to an embodiment of the present disclosure. When horizontal flip transformation is performed on the template area of a reference block as shown in FIG. 40, the present disclosure may derive a parameter for illumination compensation from the template area 4110 of a horizontally flipped reference block as shown in FIG. 41. A derived parameter may be used to generate the final prediction block of a current block.

The present disclosure is not limited thereto, and a parameter for illumination compensation may be derived from the template area of a reference block to which various transformation methods are applied, and a derived parameter may be used to generate the final prediction block of a current block.

### Embodiment 4

The present disclosure proposes a method for generating a final prediction block by further generating at least one prediction block other than a prediction block generated by using an intraTMP prediction method to which rotation and/or flip transformation is applied and weighted summing multiple prediction blocks in the unit of a block or a pixel.

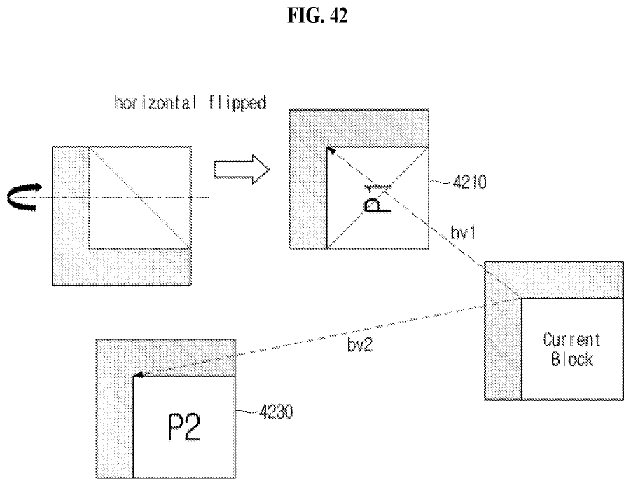

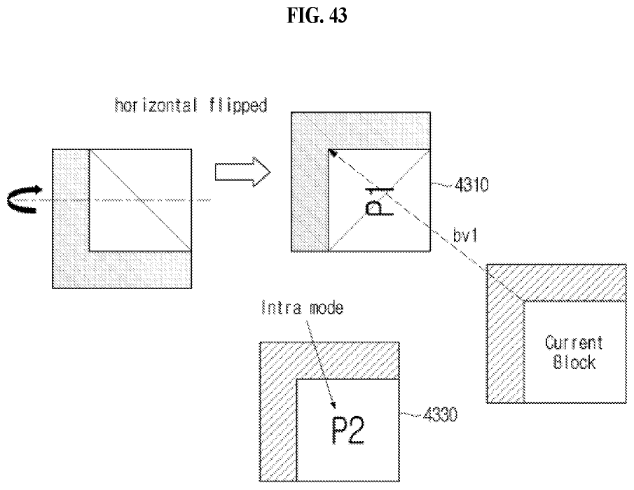

FIGS. 42 and 43 are diagrams illustrating a method for generating a final prediction block by weighted summing multiple prediction blocks according to an embodiment of the present disclosure. Referring to FIG. 42, an image encoding apparatus 100 and/or an image decoding apparatus 200 may generate a horizontal flip transformationed prediction block 4210 corresponding to one block vector (BV1) and a prediction block 4230 corresponding to another block vector (BV2). An image encoding apparatus 100 and/or an image decoding apparatus 200 may generate the final prediction block of a current block by weighted summing two generated prediction blocks 4210 and 4230.

As another example, referring to FIG. 43, an image encoding apparatus 100 and/or an image decoding apparatus 200 may generate the final prediction block of a current block by weighted summing a horizontal flip transformationed prediction block 4310 corresponding to one block vector (BV1) and a prediction block 4330 generated in an intra prediction mode. Here, an intra prediction mode used to generate a prediction block 4330 may be various intra prediction methods other than a directional mode and a non-directional mode.

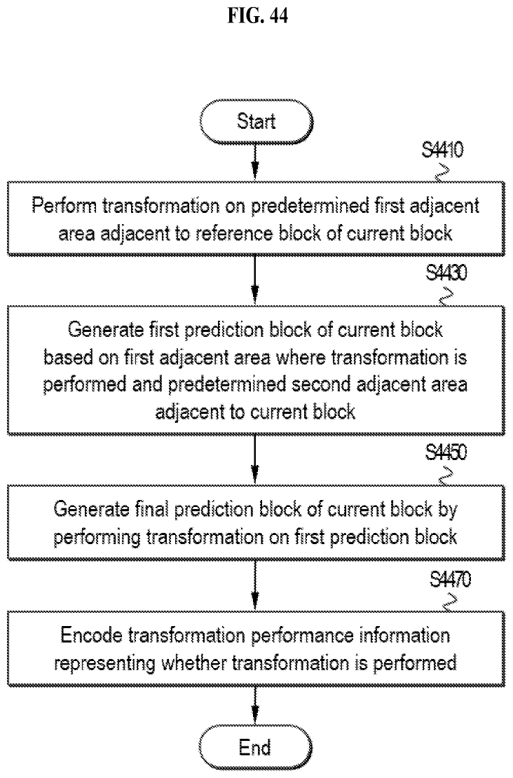

FIG. 44 is a flowchart representing an encoding method according to the present disclosure. An image encoding apparatus 100 may perform transformation on a predetermined first adjacent area adjacent to the reference block of a current block S4410. Here, the first adjacent area may be a template area adjacent to a reference block. In addition, the first adjacent area may include at least one of the left adjacent area, the top adjacent area, the top-left adjacent area, the right adjacent area or the bottom adjacent area of a reference block.

An image encoding apparatus 100 may generate the first prediction block of a current block based on the first adjacent area where transformation is performed and a predetermined second adjacent area adjacent to a current block S4430. Here, the second adjacent area may be the template area of a current block. Specifically, the first prediction block may be generated based on an error value (cost, similarity) calculated based on the first adjacent area and the second adjacent area where transformation is performed.

An image encoding apparatus 100 may generate the final prediction block of a current block by performing transformation on the first prediction block S4450. An image encoding apparatus 100 may encode transformation performance information representing whether transformation is performed S4470. Here, transformation performance information may be a flag representing whether transformation is available. In addition, transformation performance information may further include transformation type information representing a transformation type. The transformation type information may be information representing one of flip transformation or rotation transformation. Alternatively, transformation type information may be information representing one of vertical flip transformation, horizontal flip transformation, diagonal flip transformation, vertical diagonal flip transformation, 90-degree counterclockwise rotation transformation, 180-degree counterclockwise rotation transformation or 270-degree counterclockwise rotation transformation.

According to an embodiment of the present disclosure, an image encoding apparatus 100 may derive an illumination compensation parameter based on the first adjacent area and the second adjacent area where transformation is performed. Based on a derived illumination compensation parameter, an image encoding apparatus 100 may perform illumination compensation on a reference block. The first prediction block may be generated based on a reference block where illumination compensation is performed.

According to an embodiment of the present disclosure, an image encoding apparatus 100 may generate a final prediction block by weighted summing a plurality of prediction blocks. Specifically, a final prediction block may be generated by weighted summing the second prediction block generated in an intra prediction mode and the first prediction block where transformation is performed.

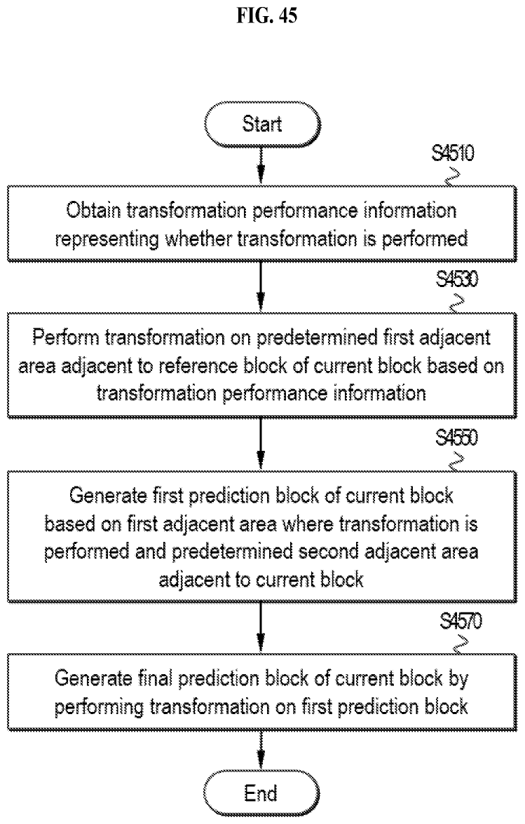

FIG. 45 is a flowchart representing a decoding method according to the present disclosure. An image decoding apparatus 200 may obtain transformation performance information representing whether transformation is performed S4510. Here, transformation performance information may be a flag representing whether transformation is available. In addition, transformation performance information may further include transformation type information representing a transformation type. The transformation type information may be information representing one of flip transformation or rotation transformation. Alternatively, transformation type information may be information representing one of vertical flip transformation, horizontal flip transformation, diagonal flip transformation, vertical diagonal flip transformation, 90-degree counterclockwise rotation transformation, 180-degree counterclockwise rotation transformation or 270-degree counterclockwise rotation transformation.

An image decoding apparatus 200 may perform transformation on a predetermined first adjacent area adjacent to the reference block of a current block based on transformation performance information S4530. Here, the first adjacent area may be a template area adjacent to a reference block. In addition, the first adjacent area may include at least one of the left adjacent area, the top adjacent area, the top-left adjacent area, the right adjacent area or the bottom adjacent area of a reference block.

An image decoding apparatus 200 may generate the first prediction block of a current block based on the first adjacent area where transformation is performed and a predetermined second adjacent area adjacent to a current block S4550. Here, the second adjacent area may be the template area of a current block. Specifically, the first prediction block may be generated based on an error value (cost, similarity) calculated based on the first adjacent area where transformation is performed and the second adjacent area. An image decoding apparatus 200 may generate the final prediction block of a current block by performing transformation on the first prediction block S4570.

According to an embodiment of the present disclosure, an image decoding apparatus 200 may derive an illumination compensation parameter based on the first adjacent area and the second adjacent area where transformation is performed. Based on a derived illumination compensation parameter, an image decoding apparatus 200 may perform illumination compensation on a reference block. The first prediction block may be generated based on a reference block where illumination compensation is performed.

According to an embodiment of the present disclosure, an image decoding apparatus 200 may generate a final prediction block by weighted summing a plurality of prediction blocks. Specifically, a final prediction block may be generated by weighted summing the second prediction block generated in an intra prediction mode and the first prediction block where transformation is performed.

According to various embodiments proposed in the present disclosure, encoding efficiency may be refined and encoding performance may be improved by performing intraTMP to which rotation transformation and/or flip transformation is applied.

Although the exemplary methods of the present disclosure are expressed as a series of operations for clarity of description, this is not intended to limit the order in which steps are performed, and if necessary, each step may be performed simultaneously or in different order. In order to implement a method according to the present disclosure, another step may be additionally included in an exemplary step or the remaining steps may be included excluding some steps or another additional step may be included excluding some steps.

In the present disclosure, an image encoding apparatus or an image decoding apparatus performing a predetermined operation (step) may perform an operation (a step) for checking a condition or a situation for performing a corresponding operation (step). For example, when it is stated that a predetermined operation is performed when a predetermined condition is satisfied, an image encoding apparatus or an image decoding apparatus may perform an operation for checking whether the predetermined condition is satisfied, and then perform the predetermined operation.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

In addition, an image decoding device and an image encoding device to which an embodiment of the present disclosure is applied may be included in a multimedia broadcasting transmitting and receiving device, a mobile communication terminal, a home cinema video device, a digital cinema video device, a surveillance camera, a video communication device, a real-time communication device such as a video communication, a mobile streaming device, a storage medium, a camcorder, a video-on-demand (VOD) service providing device, an OTT video (Over the top video) device, an Internet streaming service providing device, a three-dimensional (3D) video device, a video phone video device, a medical video device, etc., and may be used to process a video signal or a data signal. For example, an OTT video (Over the top video) device may include a game console, a Blu-ray player, an Internet-connected TV, a home theater system, a smartphone, a tablet PC, a digital video recorder (DVR), etc.

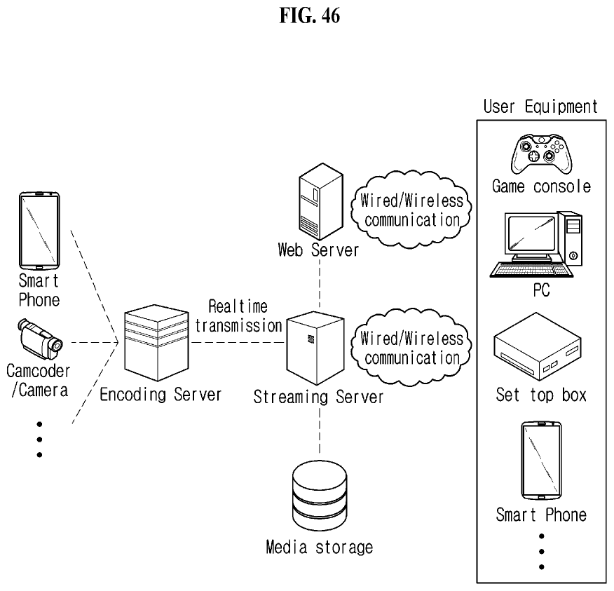

FIG. 46 shows an exemplary diagram of a content streaming system to which an embodiment of the present disclosure may be applied.

As shown in FIG. 46, the content streaming system to which an embodiment of the present disclosure is applied may broadly include an encoding server, a streaming server, a web server, a media storage, a user device, and a multimedia input device.

The encoding server compresses content input from multimedia input devices such as a smartphone, camera, or camcorder into digital data, generating a bitstream and transmitting it to the streaming server. As another example, when multimedia input devices such as a smartphone, camera, or camcorder directly generate a bitstream, the encoding server may be omitted.

The bitstream may be generated by the image encoding method and/or the image encoding apparatus to which an embodiment of the present disclosure is applied, and the streaming server may temporarily store the bitstream during the process of transmitting or receiving the bitstream.

The streaming server may transmit multimedia data to a user device based on a user request through the web server, and the web server may serve as an intermediary that informs user of available service. When a user requests a desired service from the web server, the web server may send the request to the streaming server, and the streaming server may transmit the multimedia data to the user. In this case, the content streaming system may include a separate control server, and in this case, a control server may function to control command/response exchanges between devices within the content streaming system.

The streaming server may receive content from a media storage and/or an encoding server. For example, when receiving content from the encoding server, the content may be received in real time. In this case, to provide a seamless streaming service, the streaming server may store the bitstream for a certain period of time.

Examples of the user device may include a mobile phone, a smartphone, a laptop computer, a digital broadcasting terminal, a personal digital assistant (PDA), a portable multimedia player (PMP), a navigation device, a slate PC, a tablet PC, an ultrabook, a wearable device (i.e., a smartwatch, a smart glass, a head-mounted display (HMD)), a digital TV, a desktop computer, and digital signage.

Each server within the content streaming system may be operated as a distributed server, in which case the data received by each server may be processed in a distributed manner.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

### INDUSTRIAL APPLICABILITY

The embodiments of the present disclosure may be used for encoding/decoding an image.

1. An image decoding method performed by an image decoding apparatus, comprising:
obtaining transformation performance information representing whether transformation is performed;
performing transformation on a predetermined first adjacent area adjacent to a reference block of a current block based on the transformation performance information;
generating a first prediction block of the current block based on the first adjacent area where the transformation is performed and a predetermined second adjacent area adjacent to the current block; and
generating a final prediction block of the current block by performing transformation on the first prediction block,
wherein the first adjacent area is at a position corresponding to the second adjacent area, and
wherein the transformation includes at least one of flip transformation or rotation transformation.

2. The method of claim 1, wherein the first adjacent area includes at least one of a left adjacent area, a top adjacent area, a top-left adjacent area, a right adjacent area or a bottom adjacent area of the reference block.

3. The method of claim 1, wherein the transformation performance information further includes transformation type information representing a transformation type.

4. The method of claim 1, wherein the flip transformation includes at least one of vertical flip transformation, horizontal flip transformation, diagonal flip transformation or vertical diagonal flip transformation.

5. The method of claim 1, wherein the rotation transformation includes at least one of 90-degree counterclockwise rotation transformation, 180-degree counterclockwise rotation transformation or 270-degree counterclockwise rotation transformation.

6. The method of claim 1, wherein the first prediction block is generated based on an error value calculated based on the first adjacent area where the transformation is performed and the second adjacent area.

7. The method of claim 1, wherein based on the current block being a non-square block, the first adjacent area includes a sample area within the reference block before the transform.

8. The method of claim 1, wherein generating the first prediction block further comprises:
deriving an illumination compensation parameter based on the first adjacent area where the transformation is performed and the second adjacent area;
performing illumination compensation on the reference block based on the illumination compensation parameter; and
generating the first prediction block based on a reference block where the illumination compensation is performed.

9. The method of claim 1, further comprising:
generating a second prediction block of the current block based on an intra prediction mode,
wherein the final prediction block is generated by weighted summing the first prediction block where the transformation is performed and a second prediction block.

10. An image encoding method performed by an image encoding apparatus, comprising:
performing transformation on a predetermined first adjacent area adjacent to a reference block of a current block;
generating a first prediction block of the current block based on the first adjacent area where transformation is performed and a predetermined second adjacent area adjacent to the current block;
generating a final prediction block of the current block by performing transformation on the first prediction block; and
encoding transformation performance information representing whether the transformation is performed,
wherein the first adjacent area is at a position corresponding to the second adjacent area, and
wherein the transformation includes at least one of flip transformation or rotation transformation.

11. A computer-readable recording medium storing a bitstream generated by the image encoding method of claim 10.

12. A method for transmitting a bitstream generated by an image encoding method, the image encoding method comprising:
performing transformation on a predetermined first adjacent area adjacent to a reference block of a current block;
generating a first prediction block of the current block based on the first adjacent area where transformation is performed and a predetermined second adjacent area adjacent to the current block;
generating a final prediction block of the current block by performing transformation on the first prediction block; and
encoding transformation performance information representing whether the transformation is performed,
wherein the first adjacent area is at a position corresponding to the second adjacent area, and
wherein the transformation includes at least one of flip transformation or rotation transformation.
